(19) United States
(12) Patent Application Publication
(10) Pub. No.: US 2011/0173643 A1
(43) Pub. Date: Jul. 14, 2011

(54) USING TRANSIENT PCRs TO REALISE TRUST IN APPLICATION SPACE OF A SECURE PROCESSING SYSTEM

(76) Inventors: Kenneth Alexander Nicolson, Hyogo (JP); Hideki Matsushima, Osaka (JP); Hisashi Takayama, Osaka (JP); Takayuki Ito, Osaka (JP); Tomoyuki Haga, Nara (JP)

(21) Appl. No.: 13/063,103

(22) PCT Filed: Oct. 9, 2009
(86) PCT No.: PCT/JP2009/005289

§ 371 Date: Mar. 9, 2011

(30) Foreign Application Priority Data
Oct. 10, 2008 (JP) 2008-264530
Dec. 17, 2008 (JP) 2008-321540

(51) Int. Cl. G06F 9/44

(52) U.S. Cl. 719/328

(57) ABSTRACT

A method to allow programs running within the application space of a device with a secure processor and a trusted computing base to flexibly use certificates that describe the required system state. An information processing device including PSC database (1112), Component and PSC Map (1202), and OS support (1200).

### TECHNICAL FIELD

The present invention relates to an information processing device which loads an active module and a module following the active module.

### BACKGROUND ART

Initiatives such as Non Patent Literature 1 and Non Patent Literature 2 describe how to start-up a device in an assured and trusted fashion. These methods have been thoroughly reviewed to ensure that trust and security is maintained throughout the boot process, so provide a useful baseline for those wanting to implement a device that can boot securely. A key component of this secure boot process is a RIM Certificate. This is a signed structure that defines what the current expected platform state should be, represented by a hash of a set of Platform Configuration Registers (PCRs), which themselves contain known, publically defined hash values. These PCRs act as integrity measurements that may be recorded in RIM Certificates to define an expected machine state. In addition, the RIM Certificate also specifies a PCR to be extended if the current state is verified. This extend process takes a specified PCR and calculates a new hash value based on the previous PCR value concatenated with a new known value defined within the RIM Certificate. A typical secure boot sequence as defined by the TCG starts with the initialization and self-verification of the core components such as the roots of trust for verification and for measurement (the RTV+RTM), the MTM itself and associated core MTM interface components. Next, additional components that support other parts of the firmware are started in a trusted fashion such that each component is verified by an already-trusted component before passing control to it, then the component verifies itself to ensure it has been launched from a trusted component. This sequence of verify=>execute=>self-verify has the effect of dynamically extending the trust boundary outwards from the roots of trust to each component within the system. Finally the operating system runs to provide a secure and trusted path for client applications to access MTM services.

### CITATION LIST

### Patent Literature

PTL 1: United States Unexamined Patent Application Publication No. 2006/0212939

### Non Patent Literature

NPL 1: Trusted Computing Group (TCG) Mobile Trusted Module (MTM) documents TCG Mobile Reference Architecture version 1.0 12 Jun. 2007
NPL 2: TCG Mobile Trusted Module Specification version 1.0 12 Jun. 2007
NPL 3: TCG TPM Specification Version 1.2 Revision 103

### SUMMARY OF INVENTION

### Technical Problem

However, once the secure boot process finishes writing to the PCRs matters become problematic. Unlike the secure boot components described above, normal applications will of course terminate, whether due to user interaction, faults in the program, or even detection of application tampering. Non Patent Literature 3 does allow for resetting of some PCRs under specific circumstances, but the TCG Mobile Trusted Module Specification v1.0 Revision 1 states that. PCRs controlled by RIM Certificates should not be resettable. In an informative comment within the TCG Mobile Reference Architecture v1.0 Revision 1 it suggests three solutions to this problem; not doing anything, just extending on the first run, or repeatedly extending a PCR. Not doing anything does not improve the security or trust of applications; just extending on the first run means that although the trust boundary will be extended to cover the application a rogue process could force the application within the trusted boundary to terminate then impersonate the previously-trusted application; finally repeated extends has an overhead of multiple RIM Certificate creation and storing, and creating RIM Certificates on demand at runtime provides another vector for attacking the system. In addition, PCRs are a limited resource; in section 5.3.2 page 50 of Non Patent Literature 2, thirteen PCRs are reserved for use by the Device Manufacturer during secure boot etc, leaving at worst just three other PCRs for application use, so coordination of the use of these between multiple application developers becomes a critical issue, even when these applications have no relationship to each other.

In Patent Literature 1, a method for increasing the number of PCRs is disclosed by means of creating a context that manages an unbounded set of named PCRs, but there is no consideration for how to handle RIM Certificates. Furthermore, the disclosed method of gathering all the virtual PCRs into a single physical PCR does not teach how to test only some of the virtual PCRs through a RIM Certificate, an important facet of a RIM Certificate. Furthermore, it does not teach how to avoid the problem that the gathering of virtual PCRs into a single physical PCR will interact with applications not aware of the presence of virtual PCRs but wanting to use that physical PCR for other uses. Furthermore, it does not teach how to efficiently undo an extend operation such that when an application terminates the trust boundary established by the use of virtual PCRs that extends around this application, and all applications dependent on this terminated application, is dynamically shrunk to remove them from the set of trusted applications. Instead, it only teaches that the virtual PCRs may be reset, so the only way to re-establish the trust boundary is to terminate not just the dependent applications, but also all applications that have the terminated application as a dependent, then re-verify and re-execute them all to re-establish the trust boundary from scratch.

What is needed, therefore, is a device which can generate and dynamically change value of PCRs according to trusted boundary even after one or more modules are terminated.

Additionally, initiatives such as the Trusted Computing Group's (TCG) Trusted Platform Module (TPM) documents describe how remote attestation of both the platform and of specific clients is established. For MTMs attestation of the platform is not strictly necessary, as the Secure Boot process guarantees the state of the platform. However, for application running on an MTM-based platform, attestation has not been addressed.

What is further needed, therefore, is a device that can allow a server to attest to the state of the dynamically changing PCRs

### Solution to Problem

An information processing device of a first aspect of the present invention comprising: a storing unit configured to store expected platform information for each of a plurality of modules, the expected platform information showing which module is to be loaded before the each of a plurality of modules; a management unit configured to record active information showing which of the plurality of modules is an active module, an active module being a module that has been loaded and not been terminated; a load control unit configured to, when one module following the active module is to be loaded: (i) determine which of the plurality of modules is an active module, using the active information and generate accumulated platform information by accumulating expected platform information of the active module; (ii) verify the active module has been loaded successfully by comparing the expected platform information for the one module with the accumulated platform information; (iii) load the one module when the verification succeeds; and (iv) control said management unit to update the active information to show that the one module is active module when the one module is loaded.

The present invention concerns a method, system and computer program product for implementing remote attestation of a client running within an environment using Transient PCRs.

The present invention uses the tPCR (transient PCR) RIM Certificate that the client used to verify itself on start-up as the basis for establishing the tPCR (transient PCR) values to use for attestation.

### Advantageous Effects of Invention

According to this structure, the information processing device manages the information showing which of the plurality of modules is an active module, and generates accumulated platform information by accumulating expected platform information of the active module.

Therefore, the information processing device can generate accumulated platform information corresponding to all active module(s). So, by performing verification by comparing the accumulated platform information with the expected platform information for first module to be loaded, the information processing device can verify all modules to be loaded before the first module are loaded successfully. Furthermore, by managing which of the plurality of modules is an active module, the information processing device can dynamically generate accumulated platform information (corresponding to value of PCRs) according to current trusted boundary even after one or more modules are terminated.

(Further Information about Technical Background to this Application)

The disclosure of Japanese Patent Application No. 2008-264530 filed on Oct. 10, 2008 including specification, drawings and claims is incorporated herein by reference in its entirety.

Furthermore, the disclosure of Japanese Patent Application No. 2008-321540 filed on Dec. 17, 2008 including specification, drawings and claims is also incorporated herein by reference in its entirety.

### BRIEF DESCRIPTION OF DRAWINGS

FIG. 1 illustrates a block diagram representing the prior art.

FIG. 1A illustrates a block diagram representing the prior art.

FIG. 2 illustrates a block diagram representing an embodiment of the present invention.

FIG. 2A illustrates a block diagram representing an embodiment of the present invention.

FIG. 3 illustrates a block diagram representing the modules from which PCR access is expected.

FIG. 3A illustrates a block diagram representing the relationships within a tree of Platform State Certificates.

FIG. 4 illustrates the structure of a Platform State Certificate.

FIG. 5 illustrates the structure of a RIM Certificate with extensions to support Transient PCRs.

FIG. 6 illustrates the structure of an Extended PSC Tree Node.

FIG. 7 illustrates the structure of a Component and PSC Map.

FIG. 8 illustrates a sample Platform State Certificate according to the prior art.

FIG. 9 illustrates two sample Platform State Certificates according to an aspect of the present invention and based on FIG. 8.

FIG. 10 illustrates the inter-module communication during application start-up and shut-down.

FIG. 11 illustrates a flow chart for extending a PSC.

FIG. 12 illustrates a flow chart for extending a PSC.

FIG. 13 illustrates a flow chart for extending a PSC.

FIG. 14 illustrates a transformation of an Extended PSC Tree from before undo to after undo.

FIG. 15 illustrates a flow chart for undoing extend of a PSC.

FIG. 16 illustrates a flow chart for undoing extend of a PSC.

FIG. 17 illustrates the inter-module communication during remote attestation of an application.

FIG. 18 illustrates a diagram describing a problem to be solved.

FIG. 19 illustrates a diagram describing a tPCR.

FIG. 20 illustrates a diagram describing the processing by an Information Processing Device.

FIG. 21A illustrates a block diagram representing the prior art.

FIG. 21B illustrates a block diagram representing the prior art.

FIG. 22A illustrates a block diagram representing an embodiment of the present invention.

FIG. 22B illustrates a block diagram representing an embodiment of the present invention.

FIG. 23A illustrates a block diagram representing the modules from which PCR access is expected.

FIG. 23B illustrates a block diagram representing the relationships within a tree of Platform State Certificates.

FIG. 24 illustrates the structure of a Platform State Certificate.

FIG. 25 illustrates the structure of a RIM Certificate with extensions to support Transient PCRs.

FIG. 26 illustrates the structure of an Extended PSC Tree Node.

FIG. 27 illustrates the structure of a Component and PSC Map.

FIG. 28 illustrates a sample Platform State Certificate according to the prior art.

FIG. 29 illustrates two sample Platform State Certificates according to an embodiment of the present invention and based on FIG. 28.

FIG. 30 illustrates the inter-module communication during application start-up and shut-down.

FIG. 31 illustrates a flow chart for extending a PSC.

FIG. 32 illustrates a flow chart for extending a PSC.

FIG. 33 illustrates a flow chart for extending a PSC.

FIG. 34 illustrates a transformation of an Extended PSC Tree from before undo to after undo.

FIG. 35 illustrate a flow chart for undoing extend of a PSC.

FIG. 36 illustrates a flow chart for undoing extend of a PSC.

FIG. 37A illustrates a block diagram representing the prior art for remote attestation.

FIG. 37B illustrates a block diagram representing the prior art for remote attestation.

FIG. 38A illustrates a block diagram representing another embodiment of the present invention for remote attestation.

FIG. 38B illustrates a block diagram representing another embodiment of the present invention for remote attestation.

FIG. 39 illustrates the inter-module communication during remote attestation of an application.

FIG. 40 illustrates the structure of a Quote Info record.

FIG. 41 illustrates the inter-module communication during remote attestation of an application to the tPCRs only.

### DESCRIPTION OF EMBODIMENTS

An information processing device (Device 1120) of a first aspect of the present invention comprising: a storing unit (PSC Database 1112) configured to store expected platform information (tPCR value) for each of a plurality of modules, the expected platform information showing which module is to be loaded before the each of a plurality of modules; a management unit (Component and PSC Map 1202) configured to record active information showing which of the plurality of modules is an active module, an active module being a module that has been loaded and not been terminated; and a load control unit (OS support 1200) configured to, when one module following the active module is to be loaded: (i) determine which of the plurality of modules is an active module, using the active information and generate accumulated platform information (tPCR state 1604 in the Extended PSC Tree 1206 (FIG. 6)) by accumulating expected platform information of the active module; (ii) verify the active module has been loaded successfully by comparing the expected platform information for the one module with the accumulated platform information; (iii) load the one module when the verification succeeds; and (iv) control said management unit to update active information to show that the one module is active module when the one module is loaded.

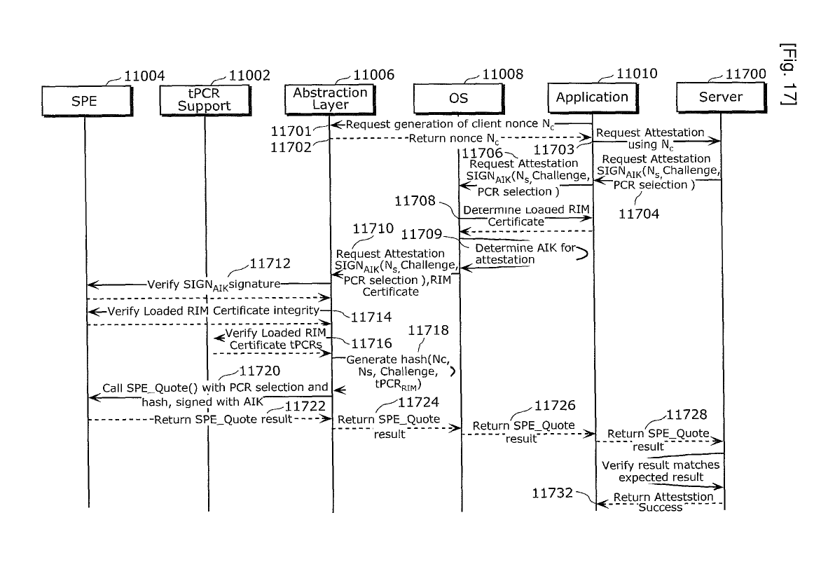

FIG. 18 illustrates a diagram describing a problem to be solved by the Information Processing Device of the first aspect.

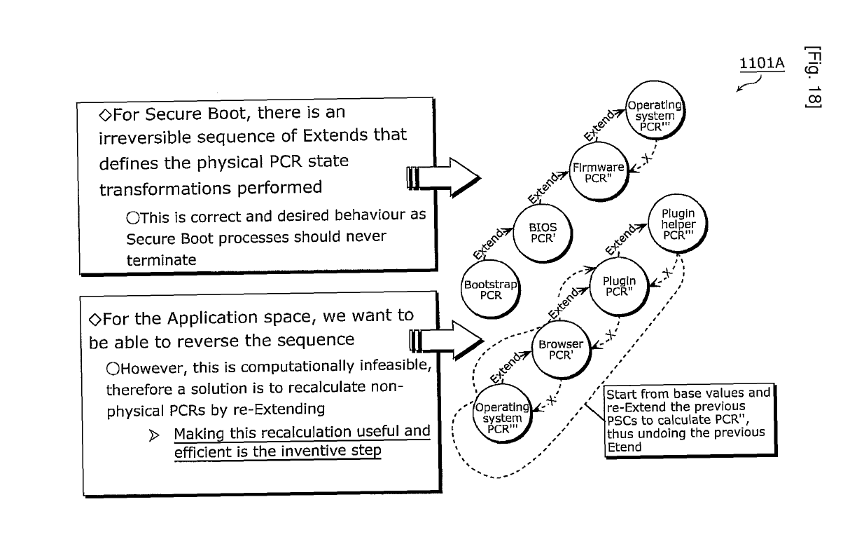

FIG. 19 illustrates a diagram describing tPCRs (Transient PCRs).

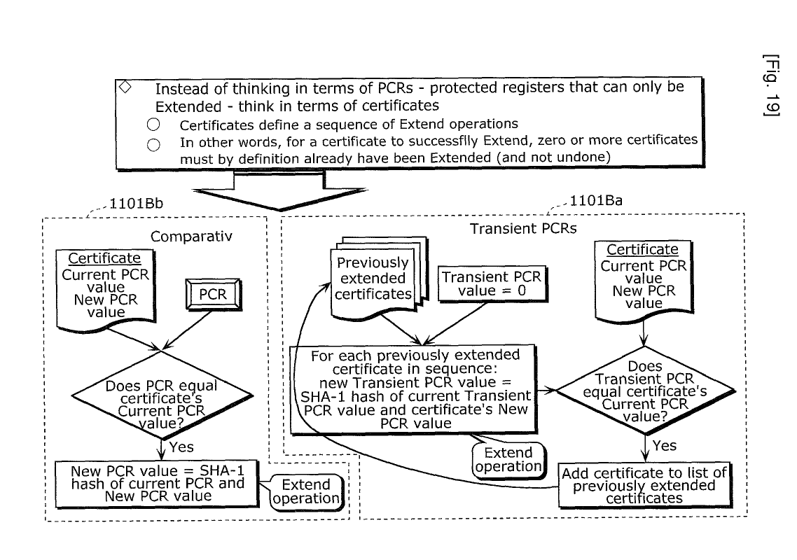

FIG. 20 illustrates a diagram describing the processing by the Information Processing Device of the first aspect.

It should be noted that FIG. 18 illustrates a transition diagram 1101A. Furthermore, FIG. 19 illustrates a column 1101Ba showing the processing by the Information Processing Device in a first aspect, and a column 1101Bb showing the conventional processing.

As described above, the Information Processing Device of the first aspect includes a storing unit (PSC database 1112), a management unit (Component and PSC Map 1202), and a load control unit (OS Support 1200). With this, the functions shown in FIG. 19 and FIG. 20 can be implemented. This allows the obtainment of an advantageous effect of solving the problem described in FIG. 18.

In contrast, the conventional example compared with the Information Processing Device of the first aspect does not include a part or all the above-mentioned units. As such, the functions shown in FIG. 19 and FIG. 20 are not implemented with the conventional example, and thus the advantageous effect of solving the problem in FIG. 18 cannot be obtained.

In other words, the Information Processing Device of the first aspect is different from the conventional example in terms of the above-described structure, operation, and advantageous effect.

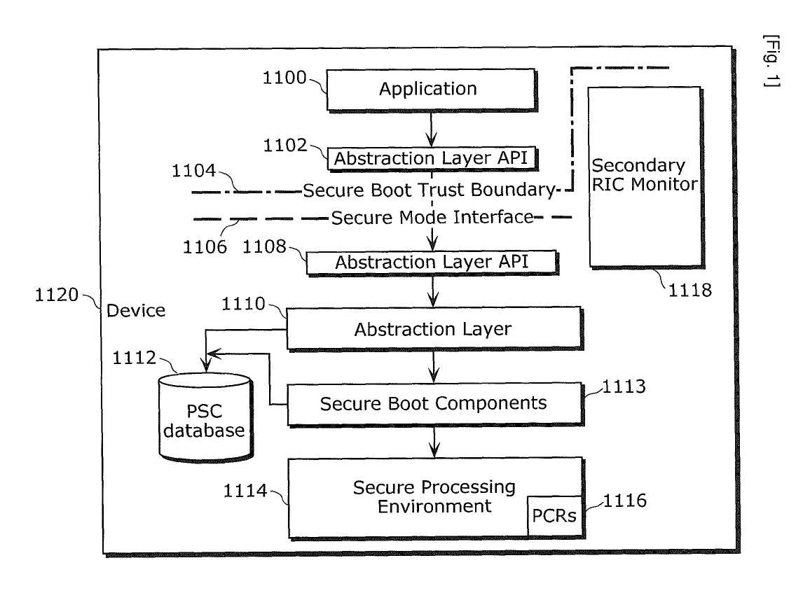

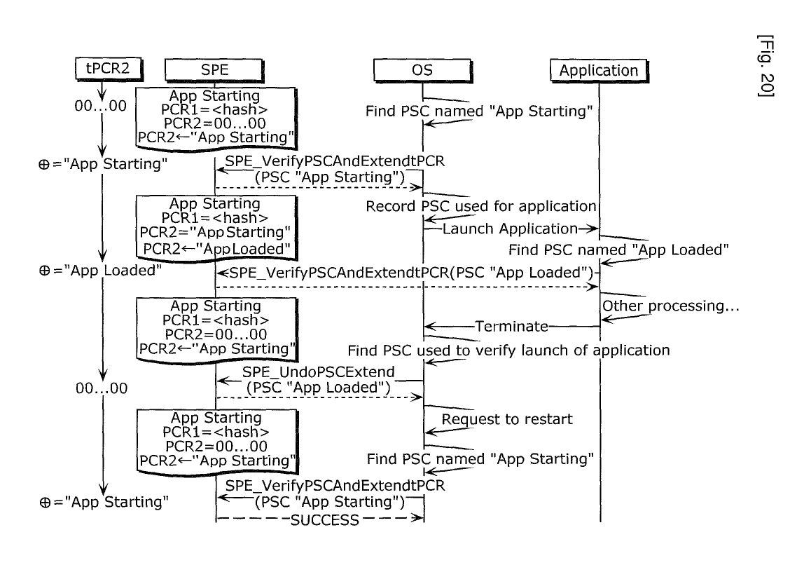

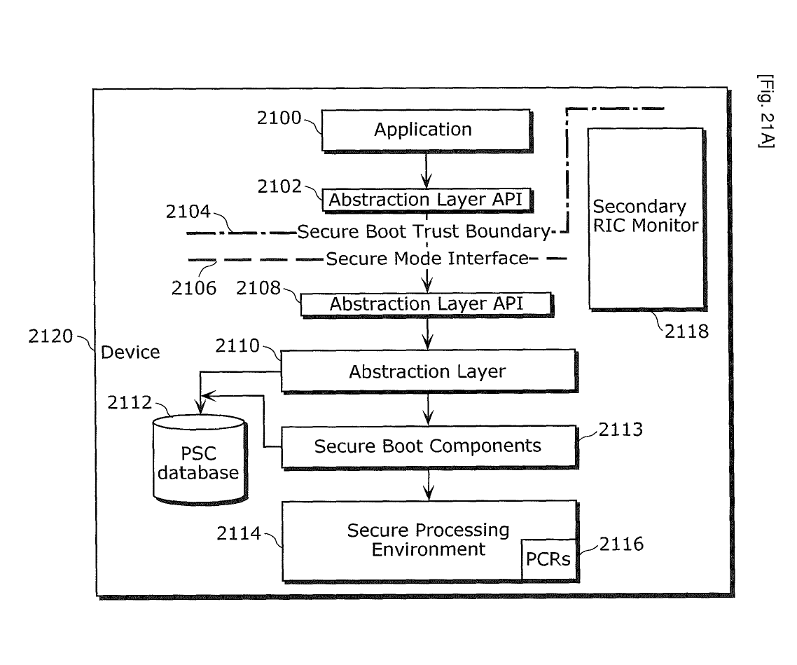

It should be noted that a Device 1120 (FIG. 1) in a first embodiment corresponds to Device 2120 (FIG. 21A) in a second and third embodiment described later. In addition, an application 1100 of the Device 1120 corresponds to an application 2100 of the Device 2120. In this manner, excluding cases of an exceptional constituent element, the respective constituent elements of the Device 1120 correspond to the same constituent elements of the Device 2120. Hereafter, detailed description regarding such correspondence between constituent elements shall be omitted.

It should be noted that detailed description of technical items described in publically-known documents shall be omitted. Here, publically-known documents include the above-mentioned “Trusted Computing Group's (TCG) Mobile Trusted Module (MTM) documents TCG Mobile Reference Architecture version 1.0 12 Jun. 2007”, “TCG Mobile Trusted Module Specification version 1.0 12 Jun. 2007”, and other documents.

An information processing device of a second aspect of the present invention is the information processing device, wherein said load control unit controls, when one module is terminated, said management unit to update the active information to show that the one module is not an active module

According to this structure, said load control unit controls, when the first module is terminated, said management unit to update the active information to show that the terminated module is not an active module.

Therefore, the information processing device can generate accumulated platform information corresponding to all active module(s) precisely corresponding to the current loaded modules even after one or more modules are terminated, by performing verification using the extended platform information.

An information processing device of a third aspect of the present invention further comprising: a judging unit (Abstraction Layer API 1108) configured to, when one module following the active module is to be loaded, calculate digest value (hash) of the one module, and judge whether or not the one module is valid by comparing expected digest value and the calculated digest value; wherein said load control unit: loads the one module when the one module is judged to be valid and the verification by said verification unit succeeds; and when at least one active module remains after one of the active module has been terminated, and when one module following the at least one active module is to be loaded, controls said calculation unit to skip the calculation of digest value of the at least one active module, and controls said judging unit to skip the judging of the at least one active module.

According to this structure, the information processing device skips to calculating the digest value of the active module and skips to judge the active module using the calculated digest value again, when at least one active module remains after one of the active module has been terminated, and when one module following the at least one active module is to be loaded.

In the prior art, the value of a PCR (corresponding to the accumulated platform information corresponding of this structure) can only be reset or accumulated. So, in order to return a PCR to its previous value after one module terminates, the PCR value must be reset then for each of the previously-executed modules, recalculate their digest values and accumulate each digest value in the PCR.

On the other hand, in this aspect of the present invention, the information processing device manages which module is the active module, and generates accumulated platform information by accumulating the expected platform information corresponding to active module. So, the calculation of the digest value of the active module and judging using the calculated digest value can be skipped. This is because these processes for the active module have been done before and the active modules are expected not to be changed since then. Therefore, by this structure processing of loading the second module can be speeded up.

An information processing device of a fourth aspect of the present invention is the information processing device, wherein said management unit manages information showing the active module by using a directed acyclic graph.

According to this structure, said management unit manages information showing the active module by using a directed acyclic graph. A plurality of modules is usually loaded by depending on and from another module, and the directed acyclic graph is suitable for expressing this relationship. Therefore, by this structure, the management unit can easily manage one or more active modules.

An information processing device of a fifth aspect of the present invention is the information processing device, wherein said load control unit controls, when the one module is loaded, said management unit to generate a node showing the one module and the expected platform information for the one module, and to add the generated node to the directed acyclic graph so that the generated node depends on a node corresponding to the dependent module.

According to this structure, the information processing device controls, when the one module is loaded, said management unit to generate a node showing the one module and the expected platform information for the one module, and to add generated node to the directed acyclic graph so that the generated node depends on a node corresponding to the dependent module. In other words, the acyclic graph will correctly reflect which active module is dependent on another active module. Therefore, by this structure, the management unit can manage dependency between active modules precisely.

An information processing device of a sixth aspect of the present invention is the information processing device, wherein said toad control unit controls, when the one module has been loaded and terminated, said management unit to delete a node showing the one module and all nodes dependent from the node showing the one module.

According to this structure, the information processing device controls, when the one module has been loaded and terminated, said management unit to delete a node showing the one module and all nodes dependent from the node showing the one module. In other words, not only the node corresponding to the terminated module but also a node depending to the node is deleted. The nodes dependent from the node of the terminated module is corresponding to child module of the terminated module, and the child module will be terminated when its parent module is terminated. Therefore, by this structure, the management unit can manage which of the plurality of modules is really being loaded precisely.

An information processing device of a seventh aspect of the present invention is the information processing device, wherein said load control unit generates the accumulated platform information by searching a parent node on which the node showing the one module is to depend, and accumulating expected platform information of each node from a root of the directed acyclic graph to the parent node.

According to this structure, said load control unit generates the accumulated platform information by searching a parent node on which the node showing the one module is to depend, and accumulating expected platform information of each node from a root of the directed acyclic graph to the parent node. By this structure, the information processing device can generate accumulated platform information reflecting which active module is to be booted before the one module correctly. This is because the directed acyclic graph reflects dependencies between active modules.

An information processing device of an eighth aspect of the present invention is the information processing device, wherein said load control unit deletes the accumulated platform information after a predetermined time period.

According to this structure, said load control unit deletes the accumulated platform information after a predetermined time period. The accumulated platform information needs to be protected from tampering, because the accumulated platform information is used to verify whether or not the active module is loaded successfully. Therefore, by this structure, the tampering is made to be difficult by limiting lifetime of the platform information.

An information processing device of a ninth aspect of the present invention is the information processing device, wherein said load control unit deletes the accumulated platform information each time one of the plurality of modules is loaded successfully, and generates accumulated platform information each time when one of the plurality of modules is to be loaded.

According to this structure, said load control unit deletes the accumulated platform information each time one of the plurality of modules is loaded successfully, and generate accumulated platform information each time when one of the plurality of modules is to be loaded. Therefore, the accumulated platform information can be protected from tampering.

An information processing device of a tenth aspect of the present invention is the information processing device, wherein the plurality of modules includes first module group and second module group, each of the first module group and the second module group including one or more modules, the information processing device, further comprises a register unit configured to store first accumulated platform information, the first accumulated platform information showing which module among the first module group has been loaded, and said storing unit, further stores first expected platform information showing all modules among the first module group are to be loaded before loading a module among the second module group, and said load control unit: for a module among the first module group, (i) verifies the module, (ii) loads the module when the verification succeeds, and (iii) updates the first accumulated platform information by accumulating the platform information of the module to the first accumulated platform information when the module is loaded; and when a module among the second module group is to be loaded, (i) verifies the all modules among the first module group have been loaded successfully by comparing the first expected platform information with the first accumulated platform information stored in said register unit, and wherein, when one module among the second module following the active module is to be loaded and when the all modules among the first module group are verified to have been loaded successfully, said load control unit: (i) determines which module among the second module group is an active module, using the active information and generates accumulated platform information by accumulating expected platforiii information of the active module; (ii) verifies the active module has been loaded successfully by comparing the expected platform information for the one module with the accumulated platform information; (iii) loads the one module when the verification succeeds; and (iv) controls said management unit to update the active information to show that the one module is active module when the one module is loaded.

According to this structure, said load control unit (i) verifies the all modules among the first module group have been loaded successfully by comparing the first expected platform information with the first accumulated platform information stored in said register unit, and (ii) performs the generating, the verifying, the loading, and the controlling for the module among the second module group when the all modules among the first module group are verified to have been loaded successfully.

By this structure the infbmiation processing device can perform verification for the first module group and the verification for the second module group separately. Therefore, the information processing device need not perform the verification of all module if some module among the second module group terminates.

Furthermore, the processing for the second module group does not start if the verification for the first module doesn't succeed. Therefore, the module among the second module group can be loaded on a trusted environment where modules including the first module are loaded successfully, even if only verification for the second module group is performed again.

An information processing device of an eleventh aspect of the present invention is the information processing device, wherein, when one module among the second module group has been terminated and one module among the second module is to be loaded, said load control unit: verifies the all modules among the first module group have been loaded successfully and are not being terminated by comparing the first expected platform information with the first accumulated platform, and skips the verification for module among the first module when the verification succeeds.

According to this structure, said load control unit verifies the all modules among the first module group have been loaded successfully and are not being terminated by comparing the first expected platform information with the first accumulated platform, and skips the verification for module among the first module when the verification succeeds.

Therefore, the information processing device can re-load terminated module among second module group, or load another module among the second module group quickly.

An information processing device of a twelfth aspect of the present invention is the information processing device, wherein the first module group includes module of system layer, and the second module group includes module of application layer.

According to this structure, the first module group includes module of system layer, and the second module group includes module of application layer.

Therefore, verification for module which are to be often terminated, such as module in application layer, can be restarted quickly even after the module terminated.

An information processing method of a thirteenth aspect of the present invention is an information processing method for an information processing device, wherein the information processing device includes a storing unit which stores expected platform information for each of a plurality of modules, the expected platform information showing which module is to be loaded before the each of a plurality of modules; and a management unit which records active information showing which of the plurality of modules is an active module, the active module being a module that has been loaded and not been terminated, and the information processing method comprises a load control step of performing, when one module following the active module is to be loaded, (i) determining which of the plurality of modules is an active module, using the active information and generating accumulated platform information by accumulating expected platform information of the active module; (ii) verifying the active module has been loaded successfully by comparing the expected platform information for the one module with the accumulated platform information; (iii) loading the one module when the verification succeeds; and (iv) controlling the management unit to update the active information to show that the one module is active module when the one module is loaded.

A program of a fourteenth aspect of the present invention is a program recorded on a recording medium for an information processing device, wherein the information processing device includes: a storing unit which stores expected platform information for each of a plurality of modules, the expected platform information showing which module is to be loaded before the each of a plurality of modules; and a management unit which records active information showing which of the plurality of modules is an active module, the active module being a module that has been loaded and not been terminated; and the program causes the information processing device to execute a load control step of performing, when one module following the active module is to be loaded; (i) determining which of the plurality of modules is an active module, using the active information and generating accumulated platform information by accumulating expected platform information of the active module; (ii) verifying the active module has been loaded successfully by comparing the expected platform information for the one module with the accumulated platform information; (iii) loading the one module when the verification succeeds; and (iv) controlling the management unit to update the active information to show that the one module is active module when the one module is loaded.

An integrated circuit device of a fifteenth aspect of the present invention is an integrated circuit device, used in an information processing device, wherein the information processing device includes: a storing unit configured to store expected platform information for each of a plurality of modules, the expected platform information showing which module is to be loaded before the each of a plurality of modules; and a management unit operable to record active information showing which of the plurality of modules is an active module, the active module being a module that has been loaded and not been terminated, and the integrated circuit device comprises a load control unit configured to, when one module following the active module is to be loaded: (i) determine which of the plurality of modules is an active module, using the active information and generate accumulated platform information by accumulating expected platform information of the active module; (ii) verify the active module has been loaded successfully by comparing the expected platform information for the one module with the accumulated platform information; (iii) load the one module when the verification succeeds; and (iv) control the management unit to update the active information to show that the one module is active module when the one module is loaded.

An information processing device of a sixteenth aspect of the present invention is the information processing device, wherein said information processing device is connected to a server, and said load control unit is further configured to, when a request for sending the accumulated platform information is received from the server: (i) determine which of the plurality of modules is an active module, using the active information and generate accumulated platform information by accumulating expected platform information of the active module; (ii) verify the active module has been loaded successfully by comparing the expected platform information for the one module with the accumulated platform information; and (iii) send the accumulated platform information to the server, when the verification succeeds.

An information processing device of a seventeenth aspect of the present invention is the information processing device, wherein said load control unit is further configured to: (i) generate information showing which piece of the expected platform is used to generate the accumulated platform information; (ii) generate signature information used for verifying the accumulated platform information based on the information; and (iii) send the accumulated platform information to which the signature information is attached to.

An information processing device of an eighteenth aspect of the present invention is the information processing device, wherein said load control unit controls, when one module is terminated, said management unit to update the active information to show that the one module is not an active module.

An information processing device of a nineteenth aspect of the present invention,

further comprising: a judging unit configured to, when one module following the active module is to be loaded, calculate digest value of the one module, and judge whether or not the one module is valid by comparing expected digest value and the calculated digest value, wherein said load control unit: loads the one module when the one module is judged to be valid and the verification by said verification unit succeeds; and when at least one active module remains after one of the active module has been terminated, and when one module following the at least one active module is to be loaded, controls said calculation unit to skip the calculation of digest value of the at least one active module, and controls said judging unit to skip the judging of the at least one active module.

An information processing device of a twentieth aspect of the present invention is the information processing device, wherein said management unit manages information showing the active module by using a directed acyclic graph.

An information processing device of a twenty-first aspect of the present invention is the information processing device, wherein said load control unit controls, when the one module is loaded, said management unit to generate a node showing the one module and the expected platform information for the one module, and to add the generated node to the directed acyclic graph so that the generated node depends on a node corresponding to the dependent module.

An information processing device of a twenty-second aspect of the present invention is the information processing device, wherein said load control unit controls, when the one module has been loaded and terminated, said management unit to delete a node showing the one module and all nodes dependent from the node showing the one module.

An information processing device of a twenty-third aspect of the present invention is the information processing device, wherein said load control unit generates the accumulated platform information by searching a parent node on which the node showing the one module is to depend, and accumulating expected platform information of each node from a root of the directed acyclic graph to the parent node.

An information processing device of a twenty-fourth aspect of the present invention is the information processing device, wherein said load control unit deletes the accumulated platform information after a predetermined time period.

An information processing device of a twenty-fifth aspect of the present invention is the information processing device, wherein said load control unit deletes the accumulated platform information each time one of the plurality of modules is loaded successfully, and generates accumulated platform information each time when one of the plurality of modules is to be loaded.

An information processing device of a twenty-sixth aspect of the present invention is the information processing device, wherein the plurality of modules includes first module group and second module group, each of the first module group and the second module group including one or more modules, said information processing device further comprises a register unit configured to store first accumulated platform information, the first accumulated platform information showing which module among the first module group has been loaded, and said storing unit, further stores first expected platform information showing all modules among the first module group are to be loaded before loading a module among the second module group, and said load control unit: for a module among the first module group, (i) verifies the module, (ii) loads the module when the verification succeeds, and (iii) updates the first accumulated platform information by accumulating the platform information of the module to the first accumulated platform information when the module is loaded; and when a module among the second module group is to be loaded, (i) verifies the all modules among the first module group have been loaded successfully by comparing the first expected platform information with the first accumulated platform information stored in said register unit, and wherein, when one module among the second module following the active module is to be loaded and when the all modules among the first module group are verified to have been loaded successfully, said load control unit: (i) determines which module among the second module group is an active module, using the active information and generates accumulated platform information by accumulating expected platform information of the active module; (ii) verifies the active module has been loaded successfully by comparing the expected platform information for the one module with the accumulated platform information; (iii) loads the one module when the verification succeeds; and (iv) controls said management unit to update the active information to show that the one module is active module when the one module is loaded.

An information processing device of a twenty-seventh aspect of the present invention is the information processing device, wherein, when one module among the second module group has been terminated and one module among the second module is to be loaded, said load control unit: verifies the all modules among the first module group have been loaded successfully and are not being terminated by comparing the first expected platform information with the first accumulated platform; and skips the verification for module among the first module when the verification succeeds.

An information processing device of a twenty-eighth aspect of the present invention is the information processing device, wherein the first module group includes module of system layer, and the second module group includes module of application layer.

The information processing method of a twenty-ninth aspect of the present invention, further comprising: a receiving step of receiving, from a server, a request for sending the accumulated platform information; and a sending step of performing, when said receiving unit receives the request: (i) determining which of the plurality of modules is an active module, using the active information and generating accumulated platform information by accumulating expected platform information of the active module; (ii) verifying the active module has been loaded successfully by comparing the expected platform information for the one module with the accumulated platform information; and (iii) sending the accumulated platform information to the server, when the verification succeeds.

The program of a thirtieth aspect of the present invention, further causing the information processing device to execute: a receiving step of receiving, from a server, a request for sending the accumulated platform information; and a sending step of performing, when said receiving unit receives the request, (i) determining which of the plurality of modules is an active module, using the active information and generating accumulated platform information by accumulating expected platform information of the active module, (ii) verifying the active module has been loaded successfully by comparing the expected platform information for the one module with the accumulated platform information, and (iii) sending the accumulated platform information to the server, when the verification succeeds.

The integrated circuit device of a thirty-first aspect of the present invention, further comprising: a receiving unit configured to receive, from a server, a request for sending the accumulated platform information; and a sending unit configured to, when said receiving unit receives the request, (i) determine which of the plurality of modules is an active module, using the active information and generate accumulated platform information by accumulating expected platform information of the active module, (ii) verify the active module has been loaded successfully by comparing the expected platform information for the one module with the accumulated platform information, and (iii) send the accumulated platform information to the server, when the verification succeeds.

What is needed is a method that will allow the trust boundary to be extended to running applications by means of PCRs and RIM Certificates while avoiding the issue of creating new certificates every time applications want to use PCRs by allowing extend operations to be undone.

What is further needed is a method that uses the RIM Certificate structures as defined by the TCG, in order to leverage existing RIM Certificate creation and management tools.

What is further needed is a method that will extend the number of PCRs available but prevent the occurrence of problems caused by two applications inadvertently sharing the same PCRs.

What is further needed is a method that will allow the trust boundary to be dynamically, efficiently, and trustworthily grown and shrunk as applications start and terminate.

This invention addresses the above-mentioned limitations in the art by implementing a transient PCR (tPCR) concept that allows applications to use RIM Certificates that securely query the state of tPCRs. These tPCRs may have lifetimes that last no longer that the lifetime of the application that uses them, or shorter if need be. The tPCRs of this invention are completely separate from the physical PCRs, so applications unaware of tPCRs may operate as before within the same environment.

According to a preferred embodiment the invention is implemented on a device equipped with an MTM, but other similar security solutions may substitute for an MTM. The key components required are a Secure Processing Environment (SPE), the aforementioned PCRs, a verification key for signing Platform State Certificates (PSCs), and methods for verifying and processing the data within a PSC. A RIM Certificate as described by the prior art is an embodiment of a PSC.

According to another preferred embodiment of the present invention, PSCs associated with an application are recorded when the application starts running, and when the application terminates the recorded PSC and all dependents have their extend operations undone.

According to another preferred embodiment, when extend operations are performed, the certificate extended is recorded within a directed acyclic graph with all other previously-extended certificates that it depends on set as children. This extend operation is undone by removing the record of the extend operation and all dependent records from the directed acyclic graph of extend operations.

According to another preferred embodiment, when an extend operation is requested, the certificates that this certificate depends on is dynamically evaluated based on the current directed acyclic graph of already-extended certificates.

### First Embodiment

A preferred embodiment of the present invention is described below.

The first embodiment relates to a system for supporting the use of transient PCRs that have a defined lifetime but values that are asserted by means of certificates. By providing the described additional operating system functionality and trusted verification of PSCs, the developer of a device with an SPE is able to produce a system that will handle these tPCRs. By providing PSCs that describe tPCRs to be used, the developers of applications on such a device are able to produce application that will provide trusted execution in a flexible manner. According to the present invention, an application is defined as any type of component including but not limited to a stand-alone program, a plugin module for a stand-alone program, and a helper module for a plugin.

FIG. 1 illustrates the prior art when there is support for securely booting the system, such as the means described within the TCG Mobile Reference Architecture. There is an Application 1100 that uses an Abstraction Layer API 1102 in the standard execution environment. The dashed line indicates the Secure Mode Interface 1106 between the aforementioned standard execution mode above and the secure mode below. Standard execution mode is a normal execution environment as provided by most computer systems. Secure mode provides a secure execution environment where only permitted software may run, in a memory space inaccessible from the standard execution environment. In a preferred embodiment of the present invention this permission is enforced by encrypting the software with the private part of a key known only to the secure mode, but other techniques such as white lists or certificates may also be used. This execution environment holds the secure boot modules and the Secure Processing Environment 1114, along with other modules as required. Above this Secure Mode Interface 1106 is the Secure Boot Trust Boundary 1104; everything below the line is within the trusted environment, established during the secure boot process of verify and extend as defined within the TCG Mobile Trusted Module Specification. The secure mode Abstraction Layer API 1108 handles requests from normal mode for services, and passes them on to the Abstraction Layer 1110 for further processing. One of the Abstraction Layer's tasks is to manage the PSC Database 1112. Another one is to handle requests for services provided by the Secure Boot Components 1113, including access to the Secure Processing Environment 1114, such as manipulating the physical PCRs 1116. The Secure Boot Components 1113 also require access to the PSC Database 1112. The Secure Processing Environment 1114 may be implemented in either hardware or software; in a preferred implementation it is a Mobile Trusted Module as defined by the Trusted Computing Group specifications, and in another preferred implementation it is a Trusted Platform Module. The Software Processing Environment 1113 may be implemented either in software or hardware, or a combination of both. Finally, there is a Secondary RIC (Runtime Integrity Checker) Monitor 1118 whose tasks include terminating Application 1100 when it appears to have been tampered with. In a preferred implementation this is achieved by verifying the current application hash versus a reference hash stored within a PSC. This verification may take place either at scheduled intervals or when specific events occur, and there may be a hierarchy of these RIC monitors with each RIC monitor level checking the integrity of one or more child RIC monitors. The Primary RIC is not illustrated, but its task is to be the master verification root for the whole system, executing outside the illustrated system, such as in a hypervisor, where it performs integrity checks on one or more components at a regular interval, verifying these component hashes versus reference hashes stored within PSCs. One of the components this Primary RIC monitors must include the Secondary RIC. The TCG Mobile Reference Architecture refers to this as a PRMVA, Primary Runtime Measurement Verification Agent, with the Secondary RIC Monitor 1118 corresponding to an SRMVA, Secondary Runtime Measurement Verification Agent. All the parts illustrate are located within the Device 1120.

The secure mode may be realised by a number of techniques known to one ordinarily-skilled in the art, such as isolated execution mode within the system processor, operating system kernel mode, security co-processor, virtual machine, hypervisor, integrity-checked memory. Each component may be protected by one or more of the listed techniques or by other techniques without materially departing from the novel teachings and advantages of this invention.

In another embodiment of the prior art, the Secure Mode Interface 1106 is located between the Abstraction Layer 1110 and the Secure Processing Environment 1114. One ordinarily-skilled in the art will see that the Abstraction Layer may be implemented such that it does not require the full protection of a secure mode for its execution, just the integrity protection provided by the RIC monitors described above, with the integrity protection provided by either software or hardware means, or a combination of both.

FIG. 1A illustrates another embodiment of the prior art when there is no support for secure mode but with an independent Secure Processing Environment, such as the means described within the TCG Specification Architecture Overview Revision 1.2 28 Apr. 2004, and there is no secure mode interface. Since there is no secure mode interface, there is just the one Abstraction Layer API 1108, and instead of only secure boot components, Trusted/Secure Boot Components 1152 are present instead. The Secondary RIC Monitor 1118 is expanded to cover all the components in the system other than the Secure Processing Environment 1114, thus helps to enforce the Trusted/Secure Boot Trust Boundary 1150 but otherwise the components and their roles are as described in FIG. 1.

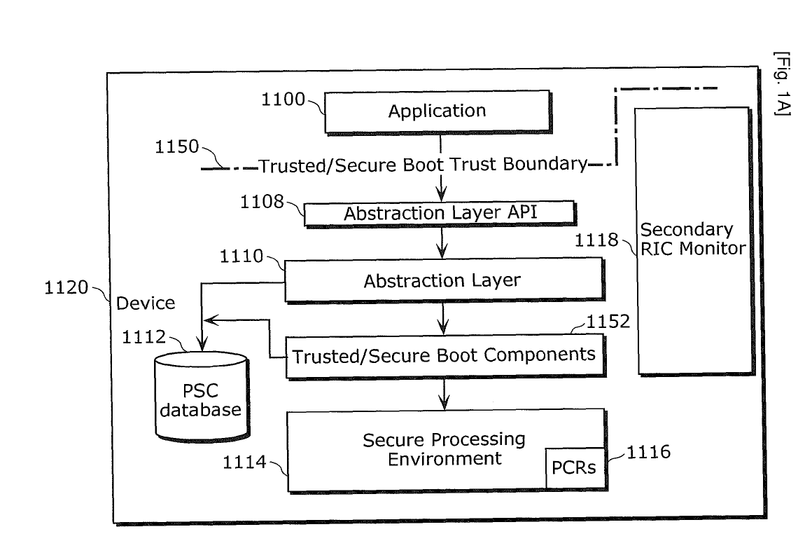

FIG. 2 illustrates the present invention, based on the prior art in FIG. 1. As before, there is an Application 1100 that uses an Abstraction Layer API 1102 in the standard execution environment. The dashed line indicates the Secure Mode Interface 1106 between the aforementioned standard execution mode above and the secure mode below. Above this Secure Mode Interface 1106 is the Secure Boot Trust Boundary 1104, established by the process of verifying components before execution as described previously; everything below the line is within the trusted environment. The OS Support 1200 module is in the standard execution space, but within the trusted boundary. This module manages the Component and PSC Map 1202 for maintaining a mapping of which application has used which certificate for verification before launch. Within the Secure Mode there is the Abstraction Layer API 1108 which handles requests from normal mode for services, and passes them on to the Abstraction Layer 1110 for further processing. One of the Abstraction Layer's tasks is to manage the PSC Database 1112, and another one is to implement the tPCR Support 1204. This support module maintains the Extended PSC Tree 1206 data that contains a directed acyclic graph of all the extended but not undone PSCs. Yet another task is to handle requests for services provided by the Secure Boot Components 1113, including access to the Secure Processing Environment 1114, such as manipulating the physical PCRs 1116. The Secure Boot Components 1113 also require access to the PSC Database 1112. Finally, there is a Secondary RIC (Runtime Integrity Checker) Monitor 1118 whose tasks include terminating Application 1100 when it appears to have been tampered with. All the parts illustrate are located within the Device 1120.

As with the prior art, in a preferred embodiment of the prior art, the Secure Mode Interface 1106 is located between the Abstraction Layer 1110 and the Secure Processing Environment 1114. One ordinarily-skilled in the art will see that the Abstraction Layer may be implemented such that it does not require the full protection of a secure mode for its execution, just the integrity protection provided by the RIC monitors described above, and the current invention may also be implemented in a integrity-protected environment, with the integrity protection provided by either software or hardware means, or a combination of both.

The secure mode may be realised by a number of techniques known to one ordinarily-skilled in the art, such as isolated execution mode within the system processor, operating system kernel mode, security co-processor, virtual machine, hypervisor, integrity-checked memory. Each component may be protected by one or more of the listed techniques or by other techniques without materially departing from the novel teachings and advantages of this invention.

In addition, one ordinarily-skilled in the art will see thia another embodiment is to move the tPCR Support 1204 and the Extended PSC Tree 1206 to within the Secure Processing Environment 1114. A further embodiment is to combine both these alternative embodiments such that the Abstraction Layer 1110 is outside of the Secure Mode Interface 1106, but the tPCR Support 1204 and the Extended PSC Tree 1206 are inside the Secure Processing Environment 1114.

FIG. 2A illustrates another embodiment of the present invention based on FIG. 1A when there is no support for secure mode but with an independent Secure Processing Environment, such as the means described within the TCG Specification Architecture Overview Revision 1.2 28 Apr. 2004, and there is no secure mode interface. Since there is no secure mode interface, there is just the one Abstraction Layer API 1108, and instead of only secure boot components, Trusted/Secure Boot Components 1152 are present instead. The Secondary RIC Monitor 1118 is expanded to cover all the components in the system other than the Secure Processing Environment 1114, thus helps to enforce the Trusted/Secure Boot Trust Boundary 1150 but otherwise the components and their roles are as described in FIG. 2.

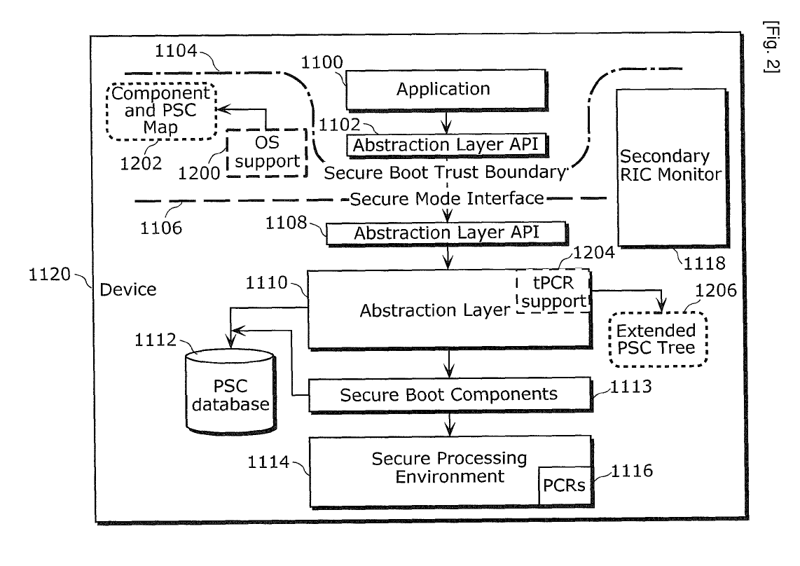

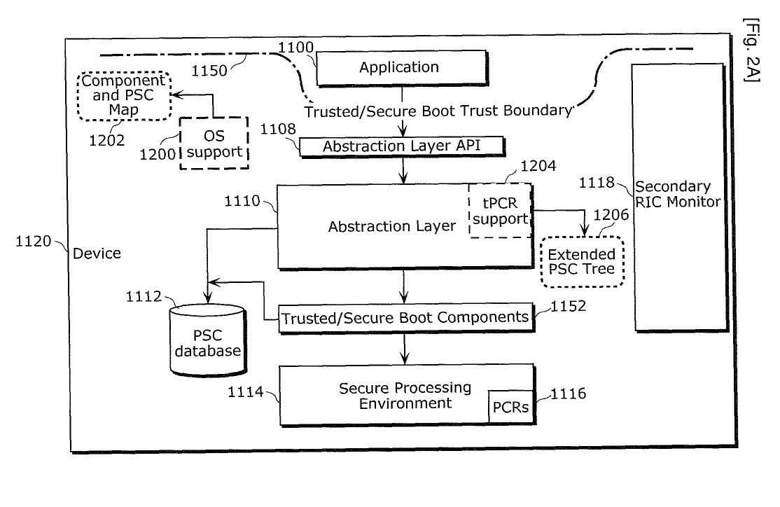

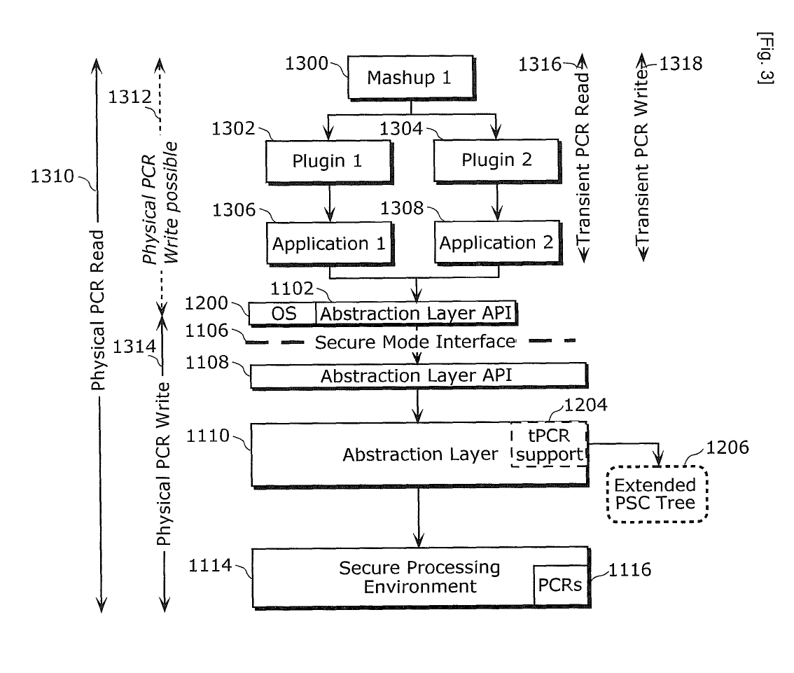

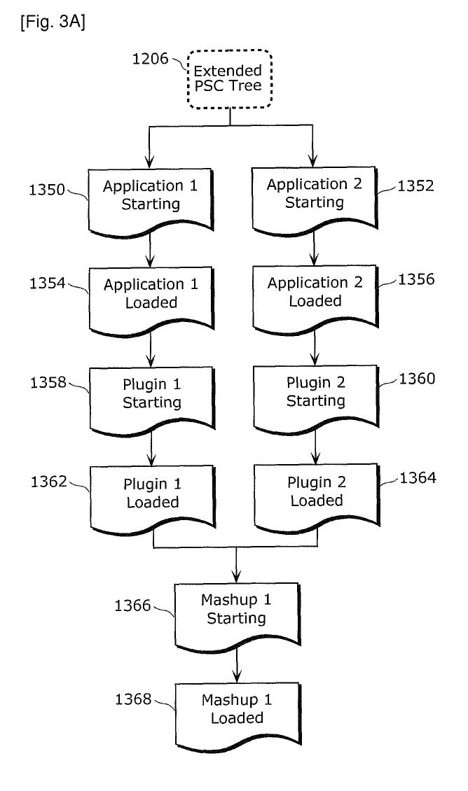

FIG. 3 illustrates a pattern of usage of the two types of PCRs according to the current invention. First, within the normal application space a hierarchy of applications are illustrated. Mashup 1 1300 uses services from Plugin 1 1302 and Plugin 2 1304. These plugins are each owned by their respective applications, Application 1 1306 and Application 2 1308. Both these applications use services from the Abstraction Layer API 1102. Next, the other side of the Secure Mode Interface 1106 the secure mode's support of the Abstraction Layer API 1108 is present. This communicates with the Abstraction Layer 1110. One of the Abstraction Layer's tasks is to implement the tPCR Support 1204. This support module maintains the Extended PSC Tree 1206 data that contains a directed acyclic graph of all the extended but not undone PSCs. Another task is to pass on to the Secure Processing Environment 1114, which may be implemented in either hardware or software, requests for manipulating the physical PCRs 1116, amongst other tasks.

Now, the typical pattern of usage of the physical PCRs 1 116 and transient PCRs 1204 is as follows. Physical PCR Read 1310 operations are always available; all functions supported by a Secure Processing Environment 1114 always use physical PCRs, never transient PCRs. However, as noted above, if the tPCR Support component 1204 were moved to within the Secure Processing Environment 1114 the SPE could use tPCRs. Writing to physical PCRs 1314 is performed primarily at boot time as taught by the prior art, but in addition physical PCR writes are possible 1312 from the application space. It is up to the system designer or implementer to decide what write operations will take place from the application space. For transient PCRs, both reading 1316 and writing 1318 normally take place exclusively in the application space. By transient PCRs' nature, each implementer has a degree of freedom to choose how to use these tPCRs, although in cases like the illustrated example, the developer of Mashup 1 1300 will need to coordinate with the developers of Plugin 1 1302 and Plugin 2 1304 to ensure that they are all aware of which tPCRs each expect to be available.

FIG. 3A illustrates an Extended PSC Tree 1206. The methods for adding and deleting nodes are described later. The directed acyclic graph illustrated represents the PSCs that the tPCR support module 1204 has recorded as being extended as shown in FIG. 2. There is a one-to-two relationship between the modules illustrated in FIG. 2 and the certificates in this figure: to extend the trust boundary to cover Application 1 1306 two certificates are needed Application 1 Starting 1350 and Application 1 Loaded 1354, as taught by the prior art. For Application 2 1308, Application 2 Starting 1352 and Application 2 Loaded 1356 are needed, for Plugin 1 1302 Plugin 1 Starting 1358 and Plugin 1 Loaded 1362 are needed, for Plugin 2 1304 Plugin 2 Starting 1360 and Plugin 2 Loaded 1364 are needed, and for Mashup 1 1300 Mashup 1 Starting 1366 and Mashup 1 Loaded 1368 are needed. The arrows between certificates indicate dependencies between these certificates. The dependencies are defined by the PCR states that each certificate expects to find when it is extended. The structure of each node within the tree is defined later in FIG. 6.

As illustrated, according to the prior art each module has two certificates associated with it, one used by its parent to verify the module before launch, and one used by the module itself to verify it has been launched in the expected environment. One ordinarily-skilled in the art will see how using more or less than two certificates per module is within the scope of the present invention.

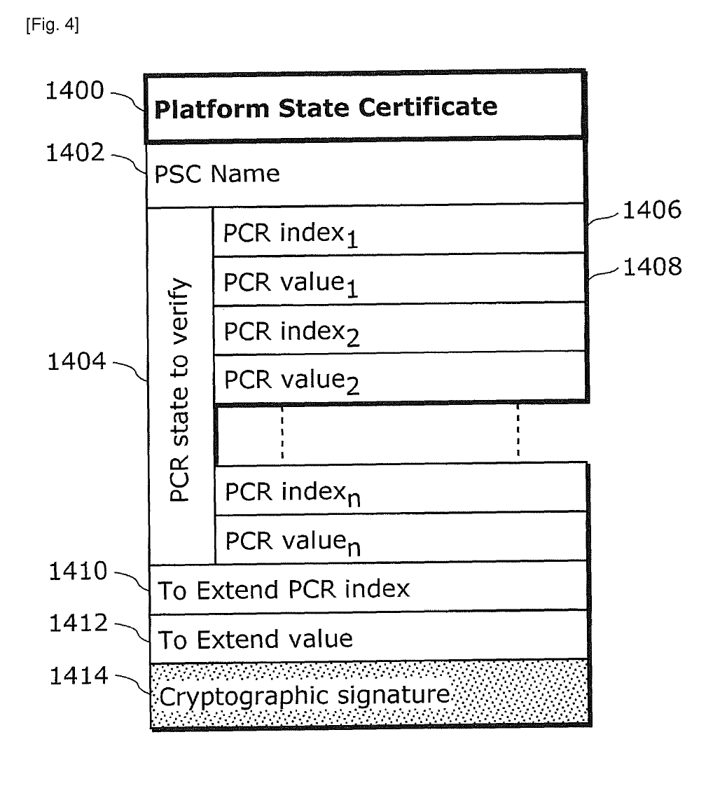

FIG. 4 illustrates a Platform State Certificate 1400 (PSC), the structure that represents the state of the platform as defined by the PCRs (either physical or transient) that it asserts and the value to extend into a PCR (either physical or transient) on a successful verification of the platform state. These structures may be stored in the PSC Database 1112. The first field within the structure is the PSC Name 1402. This name must be unique as it is the key field used to store and retrieve PSCs in the PSC Database 1112, and in the preferred implementation it is a byte string representing a human-readable name. The application developer may decide upon the name to use, or the manufacturer of the platform may provide names for the application developer. One ordinarily skilled in the art will see that other representations such as a GUID may be used instead, and there are other ways to choose the PSC names. Next, there is a list of entries representing the PCR state to verify 1404. For each PCR to be verified there is a pair of values, the PCR index 1406 and the PCR value 1408. Next, there is the PCR value to extend; first the To Extend PCR index 1410 then the To Extend value 1412. Finally there is a Cryptographic signature 1414 that represents a hash of the rest of the data encrypted by a key known to the Secure Processing Environment 1114. This signing key is either the private portion of a key securely embedded within the Secure Processing Environment 1114 or a key authorised either directly or indirectly by said embedded key as valid for signing PSCs, and the signing entity may be an agent of the platform developer or the application developer, or any other entity that has been issued with a valid signing key.

According to the current invention, by just looking at a Platform State Certificate 1400 one cannot determine whether it is for physical PCRs or transient PCRs. It is the context in which it is used that determines which kind of PCRs are to be checked. One benefit of this is that existing tools for creating certificates for secure boot can be reused for creating certificates for use in the application space.

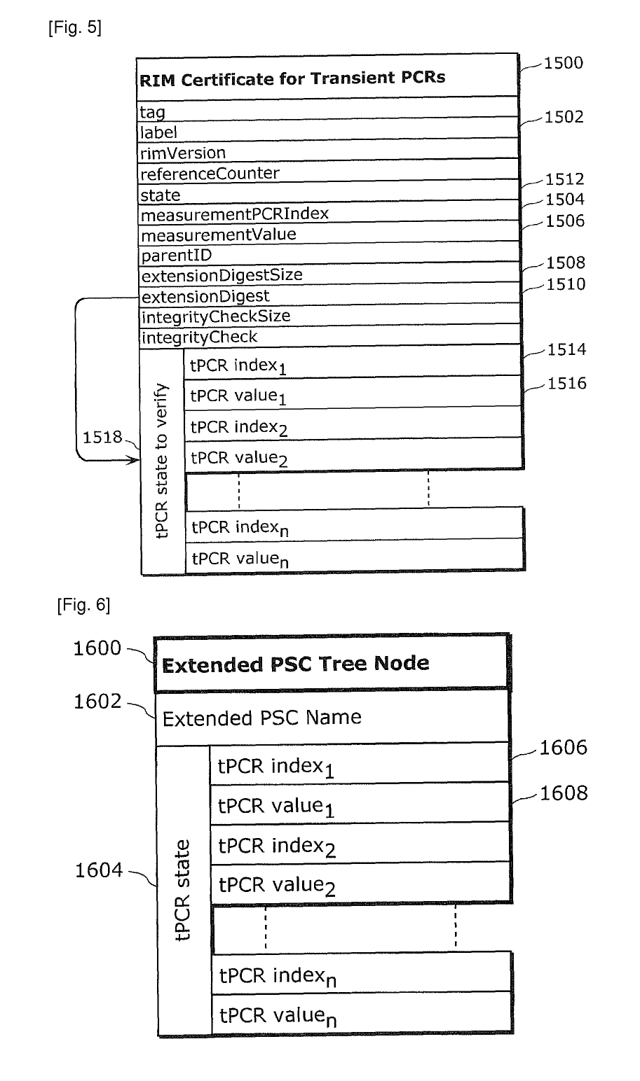

In a preferred implementation the PCR state to verify 1404 list of pairs may be replaced with a bitmap representing the PCR indices 1406 that are to be tested and a hash of the set of PCR values 1408; this is the representation defined by the TCG Mobile Trusted Module Specification for a RIM Certificate. It is possible to use such a representation without modification for certificates that verify transient PCRs, at the cost of more complex checking code, but a preferred implementation uses the RIM Certificate for Transient PCRs 1500 illustrated in FIG. 5. The relationships between fields in this structure and the Platform State Certificate in FIG. 4 and the additional fields will now be detailed.

The label 1502 is equivalent to the PSC Name 1402. The measurementPCRIndex 1504 and the measurementValue 1506 are equivalent to the To Extend PCR index 1410 then the To Extend value 1412. The tPCR state to verify 1518 and the contained list of pairs PCR index 1514 and the tPCR value 1516 are similar to the fields defined in the Platform State Certificate 1400. In order to associate the tPCR state to verify 1518 with the RIM Certificate for Transient PCRs 1500 it is necessary to use the extensionDigestSize 1508 and extensionDigest 1510 fields; the extensionDigestSize 1508 holds the size in bytes of the extensionDigest 1510 and the extensionDigest 1510 contains a hash of the tPCR state to verify 1518 structure. It is not necessary to store a size indicator as the number of bits set within the state 1512 field indicates the number of pairs in the table. One ordinarily skilled in the art will also see that it is not even necessary to store the tPCR index 1514 fields if there is a defined order of the tPCR value 1516 fields, such as tPCR index order.

FIG. 6 illustrates an Extended PSC Tree Node 1600, the structure that records the extending of a single certificate. This node structure details the contents of each node as illustrated in FIG. 3A, items 1350 to 1368. The Extended PSC Tree 1206 implements a directed acyclic graph using any well-known in the art techniques. For instance, the Boost C++ Libraries contain the Boost Graph Library, which supports the creation and manipulation of many kinds of graphs, including the above-mentioned directed acyclic graph. Thus, the Extended PSC Tree Node 1600 is associated with each vertex within the graph. The Extended PSC Name 1602 is the PSC Name 1402 field of a Platform State Certificate 1400 that has been extended. The tPCR state 1604 is a cache of the current transient PCR state at the node, as calculated from the previously-extended PSCs that are antecedents of this node. It consists of a list of pairs of tPCR index 1606 and tPCR value 1608. One ordinarily skilled in the art will see that there are alternative representations for this data, such as replacing the tPCR index 1606 fields with a bitmap representing the tPCRs used.

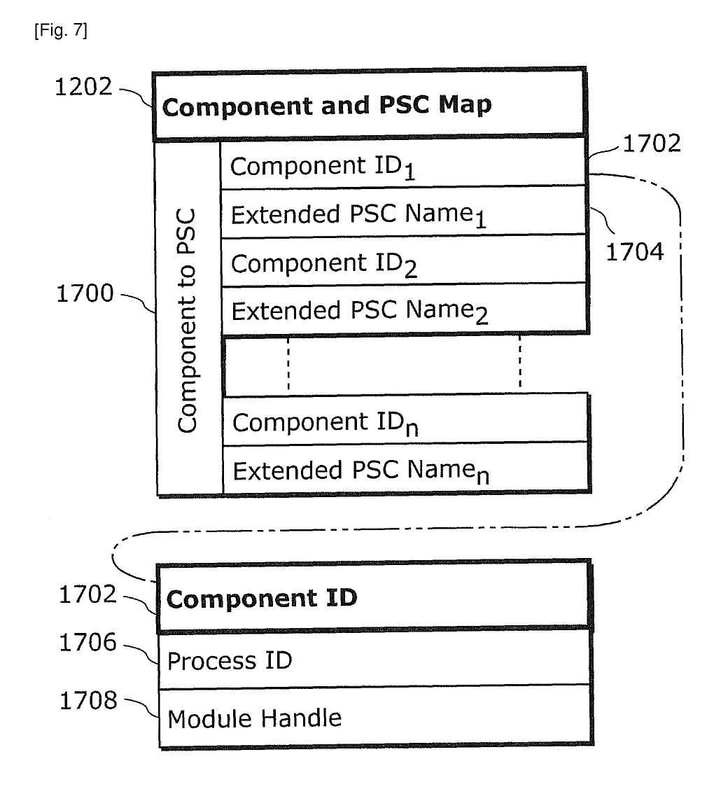

FIG. 7 illustrated the Component and PSC Map 1202 maintained by the OS support module 1200. The Component and PSC Map 1202 contains a list mapping Component to PSC 1700. Each entry of this list contains a Component ID 1702 and an Extended PSC Name 1704, the PSC Name 1402 field of a Platform State Certificate 1400 that has been extended before the launching of an application. In a preferred embodiment of the present invention on a Windows-based platform, the Component ID 1702 consists of two fields; the first is a Process ID 1706 which holds an identifier uniquely representing the process that the component belongs to, as determined by Win 32 APIs such as GetCurrentProcessId( ). The second field is a Module Handle 1708. For a component that is a stand-alone executable, this field is always set to zero. For a component implemented as a linked library, this field contains an HMODULE for the library, as passed into the DllMain entry point in the first parameter. The usage of this structure is described later:

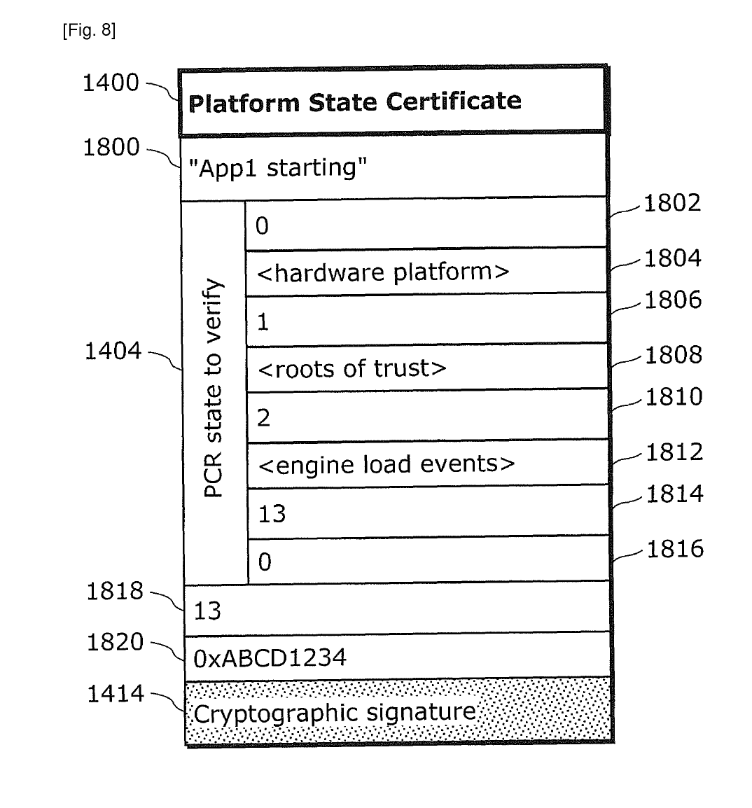

According to the TCG Mobile Reference Architecture, PCR 0 holds a value describing the characteristics of the underlying hardware platform; PCR 1 contains a value describing the Roots of Trust; PCR 2 engine load events; PCRs 3 to 6 and 8 to 12 contain proprietary measures; and PCR 13 to PCR 15 are free for application use. Assume an application programmer wanted to test PCRs 0, 1 and 2 were as expected indicating a successful secure boot, test PCR 13 was set to zeros, and if all were correct, extend a new value into PCR 13. FIG. 8 illustrates a sample Platform State Certificate 1400 named “App1 starting” according to the prior art. The name of the certificate is recorded in 1800, and as described above, the PCR state to verify 1404 contains four pairs of PCR index and PCR value to check, numbered 1802, 1804, 1806, 1808, 1810, 1812, 1814, and 1816, 1802 indicates PCR 0, 1804 the <hardware platform> notation indicates the published value representing the underlying hardware platform; 1806 indicates PCR 1, 1808 the <roots of trust> notation indicates the published value representing the underlying Roots of Trust; 1810 indicates PCR 2, 1812 the <engine load event> notation indicates the published value representing the composite hash calculated from the load event values extended into PCR 2; 1814 indicates PCR 13, 1816 the value of zero indicates expectation that the PCR 13 will still be in its initialized state. Next the PCR to extend to 1818 is present, then the value to extend into that PCR 1820.

The problems with the certificate in FIG. 8 according to the prior art include that if another application has used PCR 13, then the PCR state to verify 1404 will no longer be correct; and that if the application terminates then restarts the previously-extended value defined in 1818 and 1820 will have set PCR 13 to a non-zero state, thus the PCR state to verify 1404 will no longer be correct.

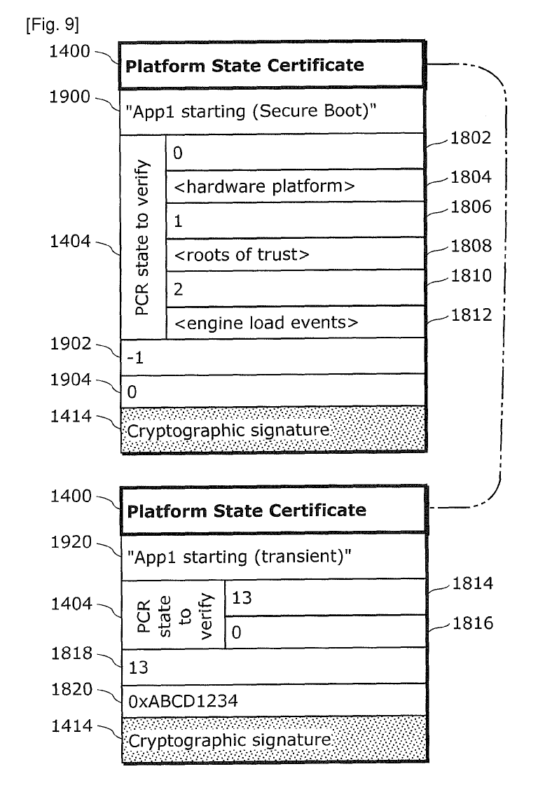

However, according to the current invention a certificate like the one in FIG. 8 is split into two certificates as illustrated in FIG. 9 by the application developer for deployment to the target device at either the same time as the application itself or at a separate time. The reason for making the split is that the existing certificates verify two distinct sets of PCRs; the first set contains the outcome of the secure boot process, a known non-varying result, and the second set the dynamic, application-level state. In FIG. 8, items 1802 and 1804 refer to the known secure boot PCR 0 value describing the hardware platform, items 1806 and 1808 refer to the known secure boot PCR 1 value describing the roots of trust, and items 1810 and 1812 refer to the known secure boot PCR 2 value describing the engine load events. In addition, items 1814 and 1816 refer to a desired post-boot PCR 13 value describing the expected preconditions. Thus, the developer of the application may split the single certificate in FIG. 8 into the two certificates illustrated in FIG. 9 by placing the known secure boot PCR values into one certificate that will be used to test the physical PCRs managed by the Secure Processing Environment, namely PCRs 0, 1 and 2 in this example. The second certificate is used for the application space transient PCRs, namely PCR 13 in this example.

The first certificate, named “App 1 starting (Secure Boot)” 1900, tests the physical PCRs (PCR 0 1802, PCR 1 1806, and PCR 2 1810) set up by the secure boot process to ensure that the secure environment is correct. However, the PCR to extend to is set to −1 1902 to indicate that there is no extend, and the value to extend 1904 is a nominal value of zero; this certificate is for verification only; at the application level writing to physical PCRs is discouraged as illustrated in FIG. 3, as using transient PCRs provides more flexibility and avoids the previously-mentioned problems present in the current state of the art. The second certificate, named “App 1 starting (transient)” 1920, tests the transient PCR 13 1814 is zero 1816 and extends a value back to the same register 1818, 1820. The choice of tPCR index 13 is purely arbitrary; tPCR 0 or tPCR 99 could just as easily be used, unlike the situation with the prior art.

FIG. 10 illustrates a sequence chart that uses the two certificates from FIG. 9 when launching an application, one for testing the physical PCRs, the other for the transient PCRs, then uses the second “App 1 starting (transient)” 1920 certificate on termination of the application to show a sequence of events according to the current invention that extends a value to a tPCR and then undoes it. Illustrated are six objects 11000, 11002, 11004, 11006, 11008 and 11010 that interact; first, tPCR 13 11000 represents the state of transient PCR 13 in the context of the current example. As illustrated in FIG. 6, tPCRs are recorded on a per node basis in the Extended PSC Tree 1206 rather than specific memory locations, but to aid understanding within this simple example, tPCR 13 11000 is represented as if it were such a location. Next, there is the tPCR Support 11002 which handles taking PSCs that refer to tPCRs and verifying the current tPCR state, and if valid, records that the certificate has been extended. SPE 11004 is the secure processing environment according to the prior art. In a preferred embodiment it is an MTM. Abstraction Layer 11006 handles requests from normal mode applications and passes requests to other modules. OS 11008 is the operating system, here concerned with handling launching and terminating applications such that the transient PCRs are correctly updates. Finally, Application 11010 is a sample application that performs arbitrary tasks, which may include requesting the launching of other applications protected by PSCs, as the processes described in the sequence chart in FIG. 10 may be nested, so that for instance Application execution 11042 may include launching another application that will follow a sequence of events starting from 11014. In order to simplify the diagram error handling has been removed from the illustration, but this removal takes nothing away from the present invention.

First of all, tPCR 13 11000 starts off ata value of zero 11012. In the present invention the rule is that the root of the Extended PSC Tree 1206 starts of with a state that has all tPCRs set to zero. One skilled in the art will see that other possible initial values are possible, such as initialising the tPCRs with the values of the physical PCRs after secure boot completes. The OS 11008 detects a request to launch the Application 11010, so first it determines which PSCs are used by the application it will attempt to launch 11014. In a preferred embodiment on a Windows-based operating system, a custom assembly embedded into the executable identifies the two PSCs to use. The application is signed using Microsoft's Strong Name tool to protect against tampering. Next, the PSCs identified in 11014, in this illustration “App1 starting (Secure Boot)” and “App1 starting (transient)”, are requested 11016, 11018 from the Abstraction Layer 11006. Now, the verification of these two PSCs is performed by calling the Abstraction Layer API AL_VerifyPSCsAndExtendtPCR with the two PSCs for verifying the application that the system wishes to start 11020, namely the PSC for the physical PCRs and the PSC for the transient PCRs as illustrated in FIG. 9. First the SPE API SPE_VerifyPSCState is called 11022 with the PSC “App1 starting (Secure Boot)”, represented as 11024 in the diagram. According to the prior art, this performs a check on the format and the signature of the PSC itself, and then verifies that the PCRs to verify within the PSC match the current values in the physical PCRs. According to the prior art, when PSCs are delivered to the platform, they are signed with a key either embedded within the Secure Processing Environment 1114 or one that can be verified as authorised by said embedded key, and if valid they are re-signed with another key generated and securely stored by the Secure Processing Environment 1114 then the certificates are stored within the PSC database 1112.

According to a preferred embodiment of the present invention, the PSC for checking the physical PCRs is optional, so steps 11016 and 11022 may be omitted. According to another preferred embodiment, if the PSCs for checking the physical PCRs are identical for all applications, one PSC for physical PCRs may be used by two or more different transient PCR PSCs.

Next another API from the SPE is called, namely SPE_VerifyPSC 11026, with the parameter set to the PSC “App1 starting (transient)”, represented as 11030 in the diagram. According to the prior art, this performs a check on the format and the signature of the PSC itself without verifying the PCR settings against the physical registers. Now the tPCR Support module 11002 is called, namely the API TPCR_VerifyPSCAndExtend 11028 with the parameter set to the PSC “App1 starting (transient)”, represented as 11030 in the diagram. The first task of this API is to verify that the PSC can be extended 11032 by checking the PCR state to verify 1404 correspond to an existing state within the Extended PSC Tree 1206. The details of this operation are described later. Once the verification completes successfully, the success of the operation on this PSC is recorded by adding a representation of it to the correct position within the Extended PSC Tree 11034. The details of this operation are described later. One outcome of adding this PSC to the tree is that tPCR 13 11000, the register to be extended to, has its value set to a hash of a concatenation of the previous value, zero in this case, and the value to extend from the PCR 11030, 0xABCD1234. This is called a composite hash, and symbolically this is written as tPCR13=SHA−1 (tPCR13 concatenated-with 0xABCD1234), and this operation is represented by the syntax (+)= in 11036. Thus, the environment has been verified to be in the expected state, and a record has been made of this success, so control passes back to the operating system. According to the prior art, as a further security measure before verifying the PSCs in 11020 a hash of the application is calculated and compared against a reference value stored within the PSC to extend. According to the present invention this value is stored within the PSC “App1 starting (transient)” 11030 as the value to extend, represented in the preferred embodiment by 0xABCD1234. However, this step is omitted from the figure.

On launching the application the OS obtains a process ID for the application and records within the Component and PSC Map 1202 this identifier and the corresponding PSC 11038 for the transient registers, PSC “App 1 starting (transient)”. In a preferred embodiment on a Microsoft Windows environment this process is implemented by intercepting the process creation process as described in Intercepting WinAPI calls by Andriy Oriekhov at The Code Project http://www.codeproject.com/KB/system/InterceptWinAPICalls.aspx. The process handle obtained is converted to a Process ID 1706 and set to the said field, and the Module Handle 1708 is set to zero. When the component is a dynamic-link library, the LoadLibrary( ) and FreeLibrary( ) code is hooked and the call to DllMain( ) trapped as described in Why does windows hold the loader lock whilst calling DllMain? by Len Holgate API at /*Rambling comments . . . */http://www.lenholgate.com/archives/000369.html. With this trap in place, the Process ID 1706 is set to the current process ID and the Module Handle 1708 is set to the first argument of DllMain( ).

The application is launched 11040, and continues to execute as programmed 11042, perhaps even launching other applications associated with PSCs or extending other PSCs that refer to tPCRs itself. Finally it terminates 11044, either due to user selecting to close it, due to a crash, or due to tamper detection by the Secondary RIC Monitor (not illustrated in this figure) forcing the application shut-down.

As the application terminates, the OS obtains the process ID of the application and uses it and a Module Handle of zero to make a Component ID 1702 that is used to look up the Component and PSC Map 1202 to find the PSC used to launch the application 11046. This returns PSC “App 1 started (transient)” 11030, so the OS calls the Abstraction Layer 11006 API AL_UndoPSCExtend 11048 with the PSC to undo. When the component is a dynamic-link library, as described above the FreeLibrary( ) API is hooked, so within that routine the current process ID is queried and the Module Handle obtained from the FreeLibrary( ) parameter, and these two data items are used to make a Component ID 1702 that is used to look up the Component and PSC Map 1202 to find the PSC used to launch the library. As before another API from the SPE is called, namely SPE_VerifyPSC 11026, with the parameter set to the PSC “App1 starting (transient)”, represented as 11030 in the diagram. According to the prior art, this performs a check on the format and the signature of the PSC itself without verifying the PCR settings against the physical registers. Now the tPCR Support module 11002 is called, namely the API TPCR_UndoPSCExtend 11050 with the parameter set to the PSC “App 1 starting (transient)”, represented as 11030 in the diagram. The first task of this API is to verify that the PSC has been extended 11052 by checking to see if the PSC is already present in the Extended PSC Tree 1206. The details of this operation are described later. Once the verification completes successfully, this means the extend operation in 11028 can be undone. This is achieved by deleting the node representing the PSC, and all other nodes that depend on it, from the Extended PSC Tree 11034. The details of this operation are described later. One outcome of deleting this PSC from the tree is that tPCR 13 11000, the register to be undone, effectively has its state reset to zero 11056. Thus, the environment has been verified to be in the expected state, and by deleting a node from the Extended PSC Tree 11034, the previously extend operation has been undone, so control passes back to the operating system, and the system is now ready to perform other operations. One ordinarily-skilled in the art will see that one of these other operations to perform is to restart the terminated application. Since tPCR 13 has been reset to 00 . . . 00 at 11056, the starting value for tPCR indicated at 11012, reperforming the verification of the application's starting PSC 11030 succeeds the second time around too, so according to the present invention applications can be restarted.

FIG. 10 illustrates the sequence chart for dynamically expanding and shrinking the trust boundary when launching and terminating an executable, with notes on how do perform the similar task for dynamic-link libraries based around a preferred embodiment using modules in the Windows Portable Executable format. For non Portable Executable-based module formats, such as Java Archive modules, or JARs, one ordinarily-skilled in the art will see that either a similar approach may be used by the engine that loads and unloads the modules, or alternatively explicit calls can be made to the Abstraction Layer 11006 by the modules themselves to expand and shrink the trust boundary. According to the prior art, JARs may contain not just Java byte codebased modules, but also other language modules, with one example being ECMAScript (JavaScript). These may be signed using the jarsigner tool from Sun at http://java.sun.com/j2se/1.3/docs/tooldocs/win32/jarsigner.html and the signature verified using the java.util.jar.JarFile class as described at http://java.sun.com/j2se/1.4.2/docs/api/java/util/jar/JarFile.html. In this case, in the preferred embodiment the Module Handle 1708 illustrated in FIG. 7 is a handle referring to the JAR file that contains the component.

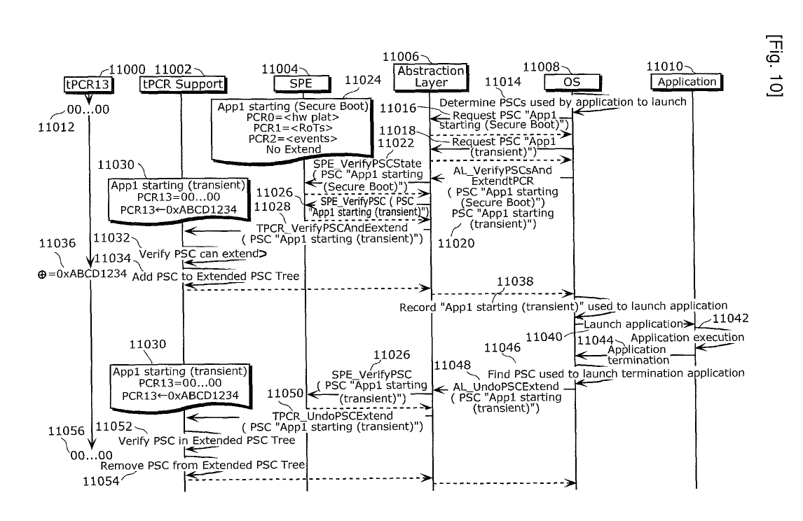

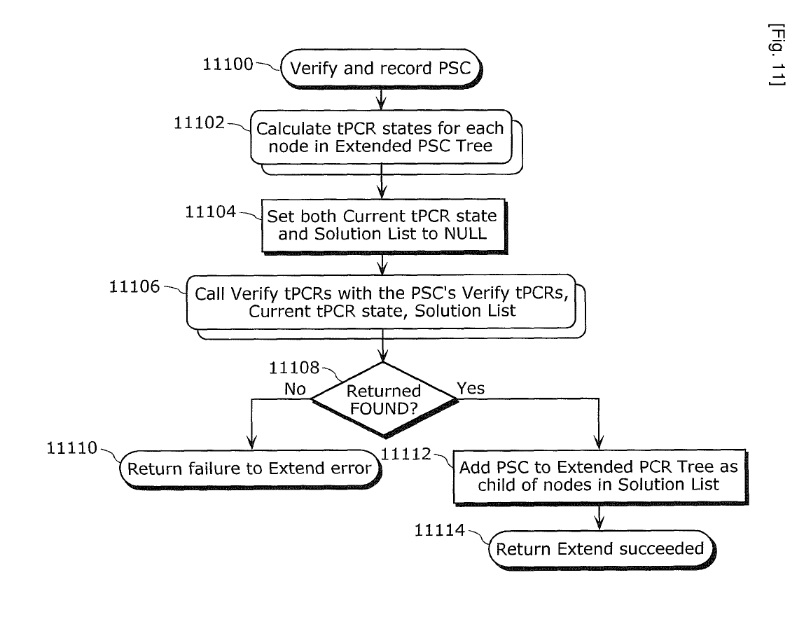

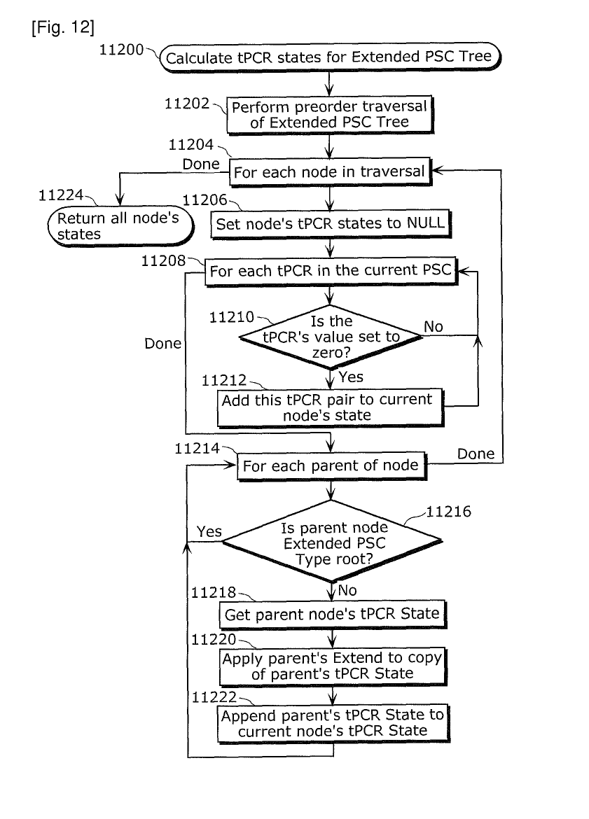

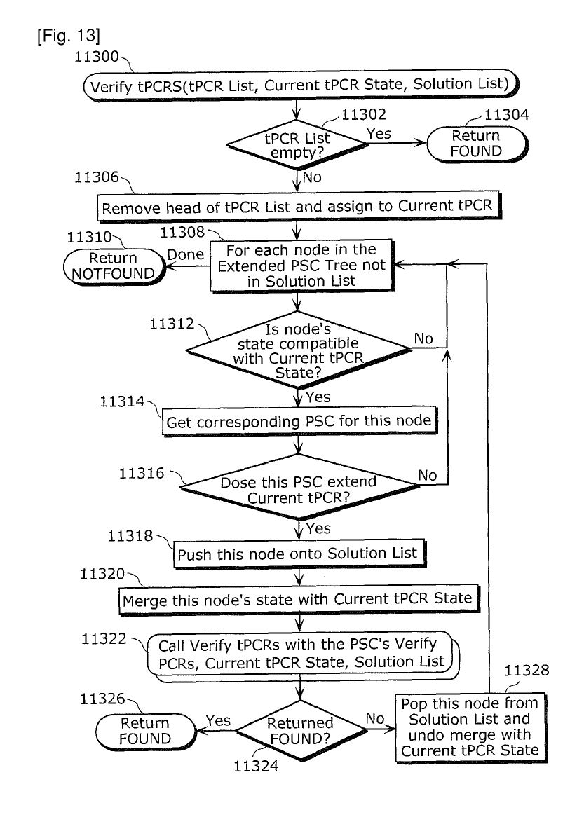

FIG. 11 illustrates a flow chart that describes the details of the tPCR Support module 11002 API TPCR_VerifyPSCAndExtend 11028. The function starts at 11100, with the PSC to verify and record being passed in as a parameter, and calls a subroutine that calculates the tPCR states for each node in the Extended PSC Tree 11102, illustrated in FIG. 12 below. Next, the Current tPCR State and Solution List variables are initialised to NULL 11104. The usage of these two variables is described in FIG. 13. Next, a subroutine that verifies the passed-in PSC's tPCR values can be reached from a state described by the current Extended PSC Tree 11106 is called. The return code is tested to see if the function found one or more nodes in the Extended PSC Tree that set the tPCRs to the state to verify held within in the passed-in PSC 11108. If this parent set was not found, the process returns an error code indicating a failure to extend to the calling routine 11110. If it was found, then the passed-in PSC is added to the Extended PSC Tree with its predecessors set to the nodes described by the Solution List 11112, and the process returns a success code to the calling routine 11114.

FIG. 12 illustrates a flow chart that describes how the tPCR states 1604 within each node of the Extended PSC Tree in FIG. 6 are calculated. The flow chart is called with no arguments 11200 and the processing starts by performing a preorder traversal of the Extended PSC Tree 11202 starting from the root in order to collect the nodes of tree in the desired order for the following processing. In a preferred implementation, the Boost Graph Library function breadth_first_search( ) is used to collect these nodes. Next, for each node recorded by the depth-first traversal 11204 the current tPCR state 1604 is set to NULL 11206. Special processing for certificates that verify tPCRs initialised to the tPCR start values as defined on the completion of secure boot, zero in a preferred embodiment, are needed, so for each tPCR pair within the PCR state to verify 1404 stored within the current certificate 11208, the value is checked against the tPCR initial value as defined on the completion of secure boot, zero in a preferred embodiment 11210, and if they are equal this pair of tPCR index and value are added to this node's tPCR state 11212, and the loop continues for the next tPCR. Otherwise, the loop continues without adding to the node's tPCR state. Once each tPCR is check, the function moves on to loop for each parent of the current node 11214. If the parent node is the Extended PSC Tree root node 11216, then there is nothing to do as the previous loop dealt with this special case. Otherwise the parent node's tPCR state 1604 is queried and copied 11218. The Extend operation defined by the PSC referred to by the parent's Extended PSC Name 1602 is performed on the copy of the parent's state 11220, and the resultant tPCR state is appended onto the current node's tPCR state 11222. Due to the way this Extended PSC Tree is constructed, there will never be a situation where two parents specify different values for the same tPCR, so one ordinarily-skilled in the art will see that checking this condition is not necessary, but may be implemented for verification purposes. This collecting of tPCR states repeats for every parent as noted before, then when finished the next node in the traversal 11204 is processed. Once each node is thus processed, the process finishes by returning the tPCR states for each node 11224.

One ordinarily-skilled in the art will see there are other ways of performing the above algorithm, such as performing steps 11204 to 11222 within a bfs_visitor's examine_vertex( ), eliminating the need for a separate list of nodes. In addition, although this function is called every time a PSC-related operation is conducted, the values may be cached to reduce required recalculation effort.

FIG. 13 illustrates a flow chart that describes how, once the tPCR states are calculated for each node, a given PSC is verified by finding a list of all the already Extended PSCs that set the tPCRs to the state defined within that given PSC. Note that the routine described in this figure is a recursive routine. The entry point to this routine takes as arguments the tPCR state to verify in the form of a list, the current matched tPCR state, and the list of nodes from the Extended PSC Tree that have been found to be parents of the PSC to match according to the tPCR state 11300. The outline of the solution method is for each tPCR index and value pair to try to find a certificate that extends the desired value into the current tPCR and is compatible with other certificates that extend into other tPCRs that are part of this solution. If a candidate is found, the routine is called recursively to find other certificates that extend the other tPCRs that are part of the PSC to match's state.

The first step is to check the list of tPCRs to match. If this is empty 11302, then the routine has successfully recursed to the end of the list, so return a FOUND value 11304 to indicate the success to the caller. Otherwise, the head of the tPCR list is removed and used as the Current tPCR to try to find a parent certificate for 11306. Each node in the Extended PSC Tree that has not already been assigned to the solution list is selected as a candidate for being a parent 11308. The description for FIG. 12 indicated how according to the prior art these nodes can be obtained. First, this node's tPCR state is checked for compatibility with the passed-in current matched tPCR state 11312, by verifying that matching tPCR indices in the two structures have the same tPCR values. If the values do not match 11316, the routine moves to the next node in the Extended PSC Tree 11308. If they do match, the PSC for the node to verify is retrieved using the Extended PSC Name 1602 stored in the node 11314, and the To Extend PSC index 1410 is compared with the index for the Current tPCR retrieved at 11306. If the indices do not match 11316, the routine moves to the next node in the Extended PSC Tree 11308. If the indices do match, then a candidate parent node has been found, so this node is pushed onto the solution list 11318 and this node's state with the Extend performed is merged with the current IPCR list. The Verify tPCRs routine is called recursively with the shortened tPCR list, the current tPCR state, and the solution list 11332. If the recursive call succeeds 11324, then a FOUND value 11326 is returned to indicate the success to the caller. If it fails, the current node is removed from the solution list and the merging of states in 11320 is undone 11328, and the loop continues to look at the next node in the tree. If all nodes are examined without a successful match, then NOTFOUND is returned 11310.

FIG. 14 illustrated the before undo and after undo states of a sample Extended PSC Tree 1206. The before undo state 11400 is as described in FIG. 3A, the resultant state built from the module tree in FIG. 3. Now, if Plugin 1 terminates either due to user interaction, a program bug, or tamper detection, as illustrated in FIG. 10 the operating system detects this termination and determines that the certificate “Plugin 1 Starting” 1358 was the PSC tested at start-up, so that certificate's extend needs to be undone. Along with “Plugin 1 Starting” 1358, all the dependent certificates must also be removed from the Extended PSC Tree 1206, namely “Plugin 1 Loaded” 1362, “Mashup 1 Starting” 1366 and “Mashup 1 Loaded” 1368, leaving the Extended PSC Tree 1206 in the after undo state 11402.

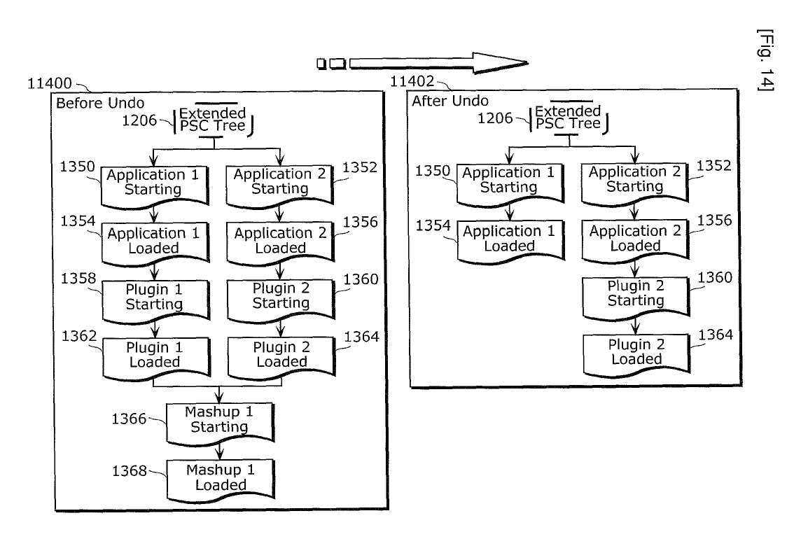

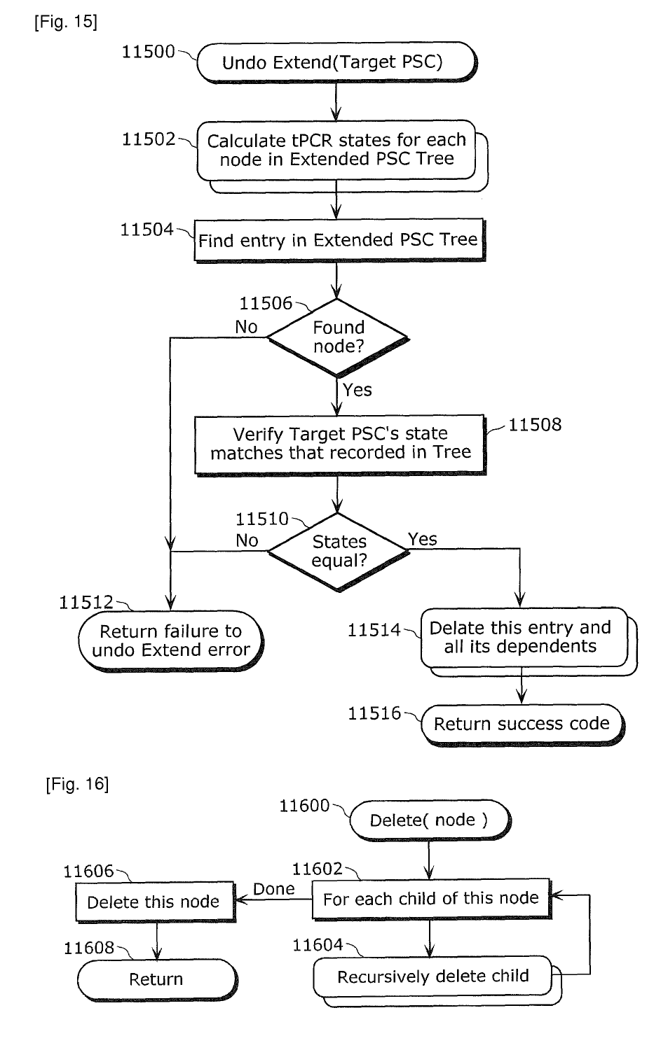

FIG. 15 illustrates a flow chart that describes how the Extend process is undone. The function takes as an argument the Target PSC to undo 11500. First, the function calls a subroutine that calculates the tPCR states for each node in the Extended PSC Tree 11502, illustrated in FIG. 12 above. Next, the reference to the Target PSC is searched for within the Extended PSC Tree 11504, trying to find a match between the Target PSC's PSC Name 1402 and each node in the tree's Extended PSC Name 1602. If a matching node is not found 11506, an error code is returned to the caller to indicate the failure to undo 11512. Next, the Target PSC's PCR state to verify 1404 is compared with the found node's tPCR state 1604, and if the states are not equal 11510, an error code is returned to the caller to indicate the failure to undo 11512. If the states are equal, then a function to delete the found node and all its descendents 11514 is called, and the function returns a success code 11516 to the caller.

FIG. 16 illustrates a flowchart that describes how the undo process removes nodes from the Extended PSC Tree. The function takes as an argument the node to delete from the tree 11600. First it loops for every child PSC of this node 11602 and recursively calls itself to delete each of its children in turn 11604. Once all children are deleted, the node itself is deleted 11606 and the function returns 11608. Thus, the trust boundary established by previous extend operations covering the terminating modules and all its dependent trusted modules is shrunk to exclude the modules to terminate, while still covering the modules that need not be terminated and without compromising the level of trust in the application space of the device.

FIG. 17 illustrates a sequence chart that illustrates the inter-module communication during remote attestation of an application. Illustrated are six objects 11004, 11002, 11006, 11008, 11010 and 11700 that interact; first, SPE 11004 is the secure processing environment according to the prior art. In a preferred embodiment it is an MTM. Next, there is the tPCR Support 11002 which handles taking PSCs that refer to tPCRs and verifying the current tPCR state, and if valid, records that the certificate has been extended. Abstraction Layer 11006 handles requests from normal mode applications and passes requests to other modules. OS 11008 is the operating system, here concerned with handling launching and terminating applications such that the transient PCRs are correctly updates. Application 11010 is a sample application that performs arbitrary tasks, including in this illustration, attestation. Finally. Server 11700 performs the remote attestation.

First, the Application 11010 requests a client nonce N_{c} 11701 from the Abstraction Layer 11006, and this randomly-generated value is returned 11702, which the Application 11010 uses when requesting attestation 11703 from the Server 11700. For example, before permitting access to secured services by the Application 11010, the Server 11700 needs to be sure that the Application 11010 is operating within the expected environment, thus the Application 11010 initiates the attestation procedure in order to obtain this permission from the Server 11700. The Application 11010 passes the generated client nonce N_{c} to the Server 11700, a value to protect against replay and other attacks. The Server 11700 replies by sending its request for attestation 11704, with a message containing a server nonce Nₛ, a randomly generated Challenge, and a set of physical PCRs to query. This message is signed using an AIK that has previously been established between the client and server using, for instance, the Direct. Anonymous Attestation protocol as described in the prior art. Note that in a preferred embodiment this message format is identical to that specified by the TCG. The Application 11010 delegates the processing of this attestation request 11706 to the OS 11008. The OS 11008 uses knowledge of the process space as described for FIG. 10 to determine which application or dynamic load library called the function and which RIM Certificate the module used to perform its self verification 11708 and to determine the AIK that has been previously established for remote attestation of the application 11709. The retrieved RIM Certificate is passed to the Abstraction Layer 11006 along with the other attestation parameters to request attestation from that module 11710. Now the attestation can start; first the signature on the message containing the server nonce, the random Challenge and the physical PCRs to attest to is verified 11712 by the SPE 11004 using the previously-established according to the prior art AIK. Next, the SPE 11004 is used again, this time to verify the integrity of the RIM Certificate 11714 for the Application 11010, and the tPCR Support 11002 is used to perform verification of the PCRs set within said RIM Certificate 11716. Assuming that these checks were performed successfully, the Abstraction Layer 11006 prepares the hash value 11718 that will be used by SPE_Quote; this hash is calculated over the concatenation of the client nonce previously sent to the server, the server nonce and Challenge passed in at 11710, and the transient PCR hash stored within the Application's 11010 RIM Certificate. The SPE 11004 is requested to generate a signed hash 11722 including the PCRs set according to the PCR selection received from the server 11704 and the hash value calculated in 11718. In a preferred embodiment where the SPE 11004 is an MTM, this function is called TPM_Quote and performs as defined by the TCG specification. This resultant value is then passed back up from the SPE 11004 to the Server 11700 through the sequence of 11722, 11724, 11726, and 11728. The Server 11700 verified that the result passed in equals the expected results 11730, and notifies the Application 11010 that attestation has completed successfully 11732.

In a preferred embodiment the communication between the Application 11010 and the Server 11700 (11703, 11704, 11728, 11730, and 11732) takes place over a wireless link through the internet, but one ordinarily skilled in the art will see that embodiments using a fixed link or a radio link are also possible. The protocol for this communication is designed such that the message contents need not be encrypted, but one ordinarily skilled in the art will see that an embodiment using an encrypted protocol such as SSL is also possible.

It should be noted that although the present invention is described based on aforementioned embodiment, the present invention is obviously not limited to such embodiment. The following cases are also included in the present invention.

(1) In aforementioned embodiment, the verification is performed in a similar manner to the MTM specifications. However, present invention can be applied to another verification system, as long as, the verification system can verify the'components of the system using a verification method in which the component are verified like a chain (i.e. one component verifies another component which launch after the one component). For example, extending the hash value into MTM may be omitted, because this operation is specific for TCG specification.

(2) In aforementioned embodiment, the verification is performed by using hash values in a certificate (RIM Certificate). However, another verification method which does not use hash values may be applied to present invention.

Conventional check sum or other data extracted from the component (for example, a first predetermined bits extracted from the component) may be used to perform verification. Furthermore, the certificate may be replaced by a data group that includes the integrity check values.

In addition, the verification method is not limited to check whether or not a value extracted from the component and an expected value match. For example, checking the size of the component, and if the size is larger or smaller than a predetermined amount the component may be judged to be verified. These verification methods are not as strict as comparing a hash value with its expected value, however they are faster to perform.

(3) Each of the aforementioned apparatuses is, specifically, a computer system including a microprocessor, a ROM, a RAM, a hard disk unit, a display unit, a keyboard, a mouse, and the so on. A computer program is stored in the RAM or hard disk unit. The respective apparatuses achieve their functions through the microprocessor's operation according to the computer program. Here, the computer program is configured by combining plural instruction codes indicating instructions for the computer.

(4) A part or all of the constituent elements constituting the respective apparatuses may be configured from a single System-LSI (Large-Scale Integration). The System-LSI is a super-multi-function LSI manufactured by integrating constituent units on one chip, and is specifically a computer system configured by including a microprocessor, a ROM, a RAM, and so on. A computer program is stored in the RAM. The System-LSI achieves its function through the microprocessor's operation according to the computer program.

Furthermore, each unit of the constituent elements configuring the respective apparatuses may be made as separate individual chips, or as a single chip to include a part or all thereof.

Furthermore, here, System-LSI is mentioned but there are instances where, due to a difference in the degree of integration, the designations IC, LSI, super LSI, and ultra LSI are used.

Furthermore, the means for circuit integration is not limited to an LSI, and implementation with a dedicated circuit or a general-purpose processor is also available. In addition, it is also acceptable to use a Field Programmable Gate Array (FPGA) that is programmable after the LSI has been manufactured, and a reconfigurable processor in which connections and settings of circuit cells within the LSI are reconfigurable.

Furthermore, if integrated circuit technology that replaces LSI appears through progress in semiconductor technology or other derived technology, that technology can naturally be used to carry out integration of the constituent elements. Biotechnology is anticipated to apply.

(5) A part or all of the constituent elements constituting the respective apparatuses may be configured as an IC card which can be attached and detached from the respective apparatuses or as a stand-alone module. The IC card or the module is a computer system configured from a microprocessor, a ROM, a RAM, and the so on. The IC card or the module may also be included in the aforementioned super-multi-function LSI. The IC card or the module achieves its function through the microprocessor's operation according to the computer program. The IC card or the module may also be implemented to be tamper-resistant.

(6) The present invention, may be a computer program for realizing the previously illustrated method, using a computer, and may also be a digital signal including the computer program.

Furthermore, the present invention may also be realized by storing the computer program or the digital signal in a computer readable recording medium such as flexible disc, a hard disk, a CD-ROM, an MO, a DVD, a DVD-ROM, a DVD-RAM, a BD (Blu-ray Disc), and a semiconductor memory. Furthermore, the present invention also includes the digital signal recorded in these recording media.

Furthermore, the present invention may also be realized by the transmission of the aforementioned computer program or digital signal via a telecommunication line, a wireless or wired communication line, a network represented by the Internet, a data broadcast and so on.

The present invention may also be a computer system including a microprocessor and a memory, in which the memory stores the aforementioned computer program and the microprocessor operates according to the computer program.

Furthermore, by transferring the program or the digital signal by recording onto the aforementioned recording media, or by transferring the program or digital signal via the aforementioned network and the like, execution using another independent computer system is also made possible.

(7) Those skilled in the art will readily appreciate that many modifications are possible in the exemplary embodiment without materially departing from the novel teachings and advantages of this invention. Accordingly, arbitrary combination of the aforementioned modifications and embodiment is included within the scope of this invention.

### Second Embodiment

A preferred embodiment of the present invention is described below.

The second embodiment relates to a system for supporting the use of transient PCRs that have a defined lifetime but values that are asserted by means of certificates. By providing the described additional operating system functionality and trusted verification of PSCs, the developer of a device with an SPE is able to produce a system that will handle these tPCRs. By providing PSCs that describe tPCRs to be used, the developers of applications on such a device are able to produce application that will provide trusted execution in a flexible manner. According to the present invention, an application is defined as any type of component including but not limited to a stand-alone program, a plugin module for a stand-alone program, and a helper module for a plugin.

FIG. 21A illustrates the prior art when there is support for securely booting the system, such as the means described within the TCG Mobile Reference Architecture. There is an Application 2100 that uses an Abstraction Layer API 2102 in the standard execution environment. The dashed line indicates the Secure Mode Interface 2106 between the aforementioned standard execution mode above and the secure mode below. Standard execution mode is a normal execution environment as provided by most computer systems. Secure mode provides a secure execution environment where only permitted software may run, in a memory space inaccessible from the standard execution environment. In a preferred embodiment of the present invention this permission is enforced by encrypting the software with the private part of a key known only to the secure mode, but other techniques such as white lists or certificates may also be used. This execution environment holds the secure boot modules and the Secure Processing Environment 2114, along with other modules as required. Above this Secure Mode Interface 2106 is the Secure Boot Trust Boundary 2104; everything below the line is within the trusted environment, established during the secure boot process of verify and extend as defined within the TCG Mobile Trusted Module Specification. The secure mode Abstraction Layer API 2108 handles requests from normal mode for services, and passes them on to the Abstraction Layer 2110 for further processing. One of the Abstraction Layer's tasks is to manage the PSC Database 2112. Another one is to handle requests for services provided by the Secure Boot Components 2113, including access to the Secure Processing Environment 2114, such as manipulating the physical PCRs 2116. The Secure Boot Components 2113 also require access to the PSC Database 2112. The Secure Processing Environment 2114 may be implemented in either hardware or software; in a preferred implementation it is a Mobile Trusted Module as defined by the Trusted Computing Group specifications, and in another preferred implementation it is a Trusted Platform Module. The Software Processing Environment 2113 may be implemented either in software or hardware, or a combination of both. Finally, there is a secondary RIC (Runtime Integrity Checker) Monitor 2118 whose tasks include terminating Application 2100 when it appears to have been tampered with. In a preferred implementation this is achieved by verifying the current application hash versus a reference hash stored within a PSC. This verification may take place either at scheduled intervals or when specific events occur, and there may be a hierarchy of these RIC monitors with each RIC monitor level checking the integrity of one or more child RIC monitors. The Primary RIC is not illustrated, but its task is to be the master verification root for the whole system, executing outside the illustrated system, such as in a hypervisor, where it performs integrity checks on one or more components at a regular interval, verifying these component hashes versus reference hashes stored within PSCs. One of the components this Primary RIC monitors must include the Secondary RIC. The TCG Mobile Reference Architecture refers to this as a PRMVA, Primary Runtime Measurement Verification Agent, with the Secondary RIC Monitor 2118 corresponding to an SRMVA, Secondary Runtime Measurement Verification Agent. All the parts illustrate are located within the Device 2120.

The secure mode may be realised by a number of techniques known to one ordinarily-skilled in the art, such as isolated execution mode within the system processor, operating system kernel mode, security co-processor, virtual machine, hypervisor, integrity-checked memory. Each component may be protected by one or more of the listed techniques or by other techniques without materially departing from the novel teachings and advantages of this invention.

In another embodiment of the prior art, the Secure Mode Interface 2106 is located between the Abstraction Layer 2110 and the Secure Processing Environment 2114. One ordinarily-skilled in the art will see that the Abstraction Layer may be implemented such that it does not require the full protection of a secure mode for its execution, just the integrity protection provided by the RIC monitors described above, with the integrity protection provided by either software or hardware means, or a combination of both.

FIG. 21B illustrates another embodiment of the prior art when there is no support for secure mode but with an independent Secure Processing Environment, such as the means described within the TCG Specification Architecture Overview Revision 1.2 28 Apr. 2004, and there is no secure mode interface. Since there is no secure mode interface, there is just the one Abstraction Layer API 2108, and instead of only secure boot components, Trusted/Secure Boot Components 2152 are present instead. The Secondary RIC Monitor 2118 is expanded to cover all the components in the system other than the Secure Processing Environment 2114, thus helps to enforce the Trusted/Secure Boot Trust Boundary 2150 but otherwise the components and their roles are as described in FIG. 21A.

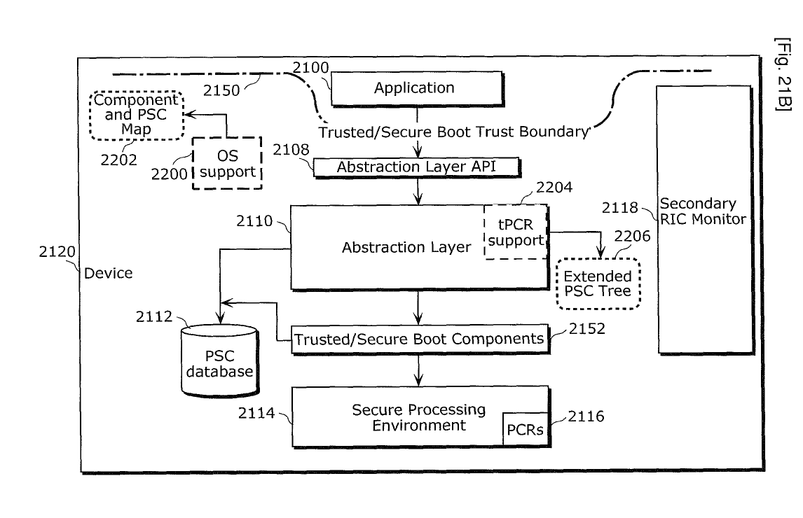

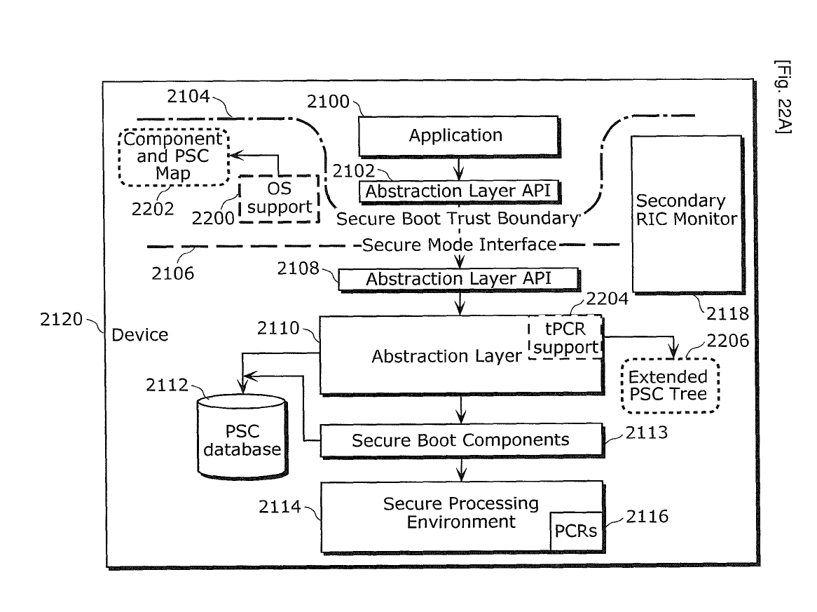

FIG. 22A illustrates the second embodiment of the present invention, based on the prior art in FIG. 21Bs before, there is an Application 2100 that uses an Abstraction Layer API 2102 in the standard execution environment. The dashed line indicates the Secure Mode Interface 2106 between the aforementioned standard execution mode above and the secure mode below. Above this Secure Mode Interface 2106 is the Secure Boot Trust Boundary 2104, established by the process of verifying components before execution as described previously; everything below the line is within the trusted environment. The OS Support 2200 module is in the standard execution space, but within the trusted boundary. This module manages the Component and PSC Map 2202 for maintaining a mapping of which application has used which certificate for verification before launch. Within the Secure Mode there is the Abstraction Layer API 2108 which handles requests from normal mode for services, and passes them on to the Abstraction Layer 2110 for further processing. One of the Abstraction Layer's tasks is to manage the PSC Database 2112, and another one is to implement the tPCR Support 2204. This support module maintains the Extended PSC Tree 2206 data that contains a directed acyclic graph of all the extended but not undone PSCs. Yet another task is to handle requests for services provided by the Secure Boot Components 2113, including access to the Secure Processing Environment 2114, such as manipulating the physical PCRs 2116. The Secure Boot Components 2113 also require access to the PSC Database 2112. Finally, there is a Secondary RIC (Runtime Integrity Checker) Monitor 2118 whose tasks include terminating Application 2100 when it appears to have been tampered with. All the parts illustrate are located within the Device 2120.

As with the prior art, in a preferred embodiment of the prior art, the Secure Mode Interface 2106 is located between the Abstraction Layer 2110 and the Secure Processing Environment 2114. One ordinarily-skilled in the art will see that the Abstraction Layer may be implemented such that it does not require the full protection of a secure mode for its execution, just the integrity protection provided by the RIC monitors described above, and the current invention may also be implemented in a integrity-protected environment, with the integrity protection provided by either software or hardware means, or a combination of both.

The secure mode may be realised by a number of techniques known to one ordinarily-skilled in the art, such as isolated execution mode within the system processor, operating system kernel mode, security co-processor, virtual machine, hypervisor, integrity-checked memory. Each component may be protected by one or more of the listed techniques or by other techniques without materially departing from the novel teachings and advantages of this invention.

In addition, one ordinarily-skilled in the art will see that another embodiment is to move the tPCR Support 2204 and the Extended PSC Tree 2206 to within the Secure Processing Environment 2114. A further embodiment is to combine both these alternative embodiments such that the Abstraction Layer 2110 is outside of the Secure Mode Interface 2106, but the tPCR Support 2204 and the Extended PSC Tree 2206 are inside the Secure Processing Environment 2114.

FIG. 22B illustrates another aspect of the second embodiment of the present invention based on FIG. 21B when there is no support for secure mode but with an independent Secure Processing Environment, such as the means described within the TCG Specification Architecture Overview Revision 1.2 28 Apr. 2004, and there is no secure mode interface. Since there is no secure mode interface, there is just the one Abstraction Layer API 2108, and instead of only secure boot components, Trusted/Secure Boot Components 2152 are present instead. The Secondary RIC Monitor 2118 is expanded to cover all the components in the system other than the Secure Processing Environment 2114, thus helps to enforce the Trusted/Secure Boot Trust Boundary 2150 but otherwise the components and their roles are as described in FIG. 22A.

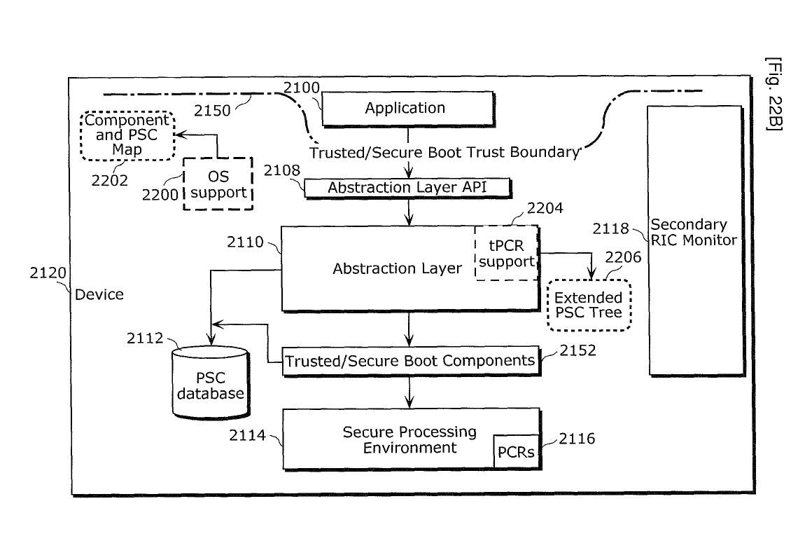

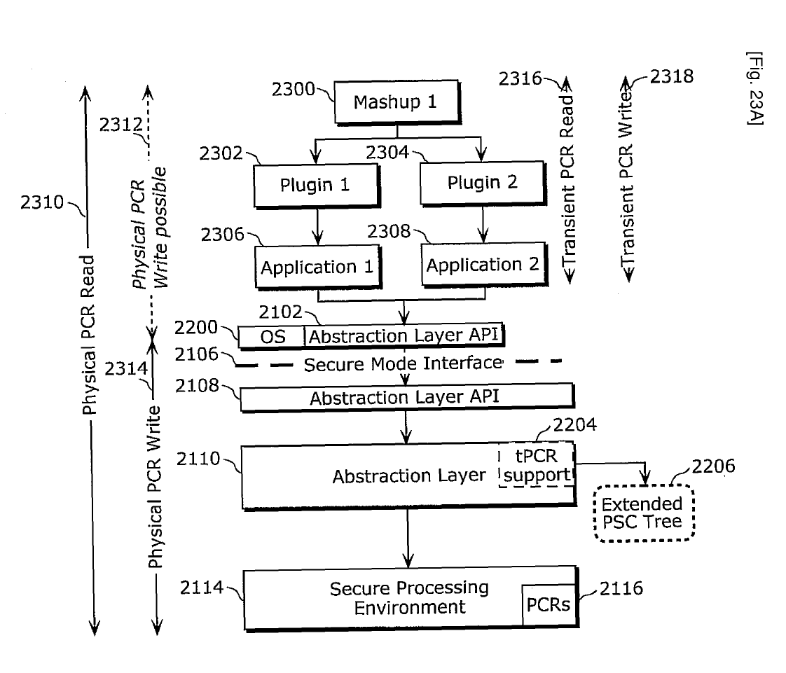

FIG. 23A illustrates a pattern of usage of the two types of PCRs according to the current invention. First, within the nomml application space a hierarchy of applications are illustrated. Mashup 1 2300 uses services from Plugin 1 2302 and Plugin 2 2304. These plugins are each owned by their respective applications, Application 1 2306 and Application 2 2308. Both these applications use services from the Abstraction Layer API 2102. Next, the other side of the Secure Mode Interface 2106 the secure mode's support of the Abstraction Layer API 2108 is present. This communicates with the Abstraction Layer 2110. One of the Abstraction Layer's tasks is to implement the tPCR Support 2204. This support module maintains the Extended PSC Tree 2206 data that contains a directed acyclic graph of all the extended but not undone PSCs. Another task is to pass on to the Secure Processing Environment 2114, which may be implemented in either hardware or software, requests for manipulating the physical PCRs 2116, amongst other tasks.

Now, the typical pattern of usage of the physical PCRs 2116 and transient PCRs 2204 is as follows. Physical PCR Read 2310 operations are always available; all functions supported by a Secure Processing Environment 2114 always use physical PCRs, never transient PCRs. However, as noted above, if the tPCR Support component 2204 were moved to within the Secure Processing Environment 2114 the SPE could use tPCRs. Writing to physical PCRs 2314 is performed primarily at boot time as taught by the prior art, but in addition physical PCR writes are possible 2312 from the application space. It is up to the system designer or implementer to decide what write operations will take place from the application space. For transient PCRs, both reading 2316 and writing 2318 normally take place exclusively in the application space. By transient PCRs' nature, each implementer has a degree of freedom to choose how to use these tPCRs, although in cases like the illustrated example, the developer of Mashup 1 2300 will need to coordinate with the developers of Plugin 1 2302 and Plugin 2 2304 to ensure that they are all aware of which tPCRs each expect to be available.

FIG. 23B illustrates an Extended PSC Tree 2206. The methods for adding and deleting nodes are described later. The directed acyclic graph illustrated represents the PSCs that the tPCR support module 2204 has recorded as being extended as shown in FIG. 22A. There is a one-to-two relationship between the modules illustrated in FIG. 22A and the certificates in this figure: to extend the trust boundary to cover Application 1 2306 two certificates are needed Application 1 Starting 2350 and Application 1 Loaded 2354, as taught by the prior art. For Application 2 2308, Application 2 Starting 2352 and Application 2 Loaded 2356 are needed, for Plugin 1 2302 Plugin 1 Starting 2358 and Plugin 1 Loaded 2362 are needed, for Plugin 2 2304 Plugin 2 Starting 2360 and Plugin 2 Loaded 2364 are needed, and for Mashup 12300 Mashup 1 Starting 2366 and Mashup 1 Loaded 2368 are needed. The arrows between certificates indicate dependencies between these certificates. The dependencies are defined by the PCR states that each certificate expects to find when it is extended. The structure of each node within the tree is defined later in FIG. 26.

As illustrated, according to the prior art each module has two certificates associated with it, one used by its parent to verify the module before launch, and one used by the module itself to verify it has been launched in the expected environment. One ordinarily-skilled in the art will see how using more or less than two certificates per module is within the scope of the present invention.

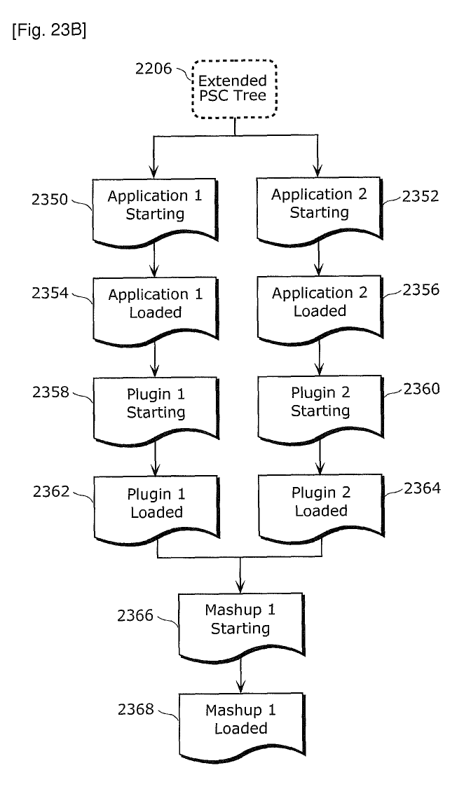

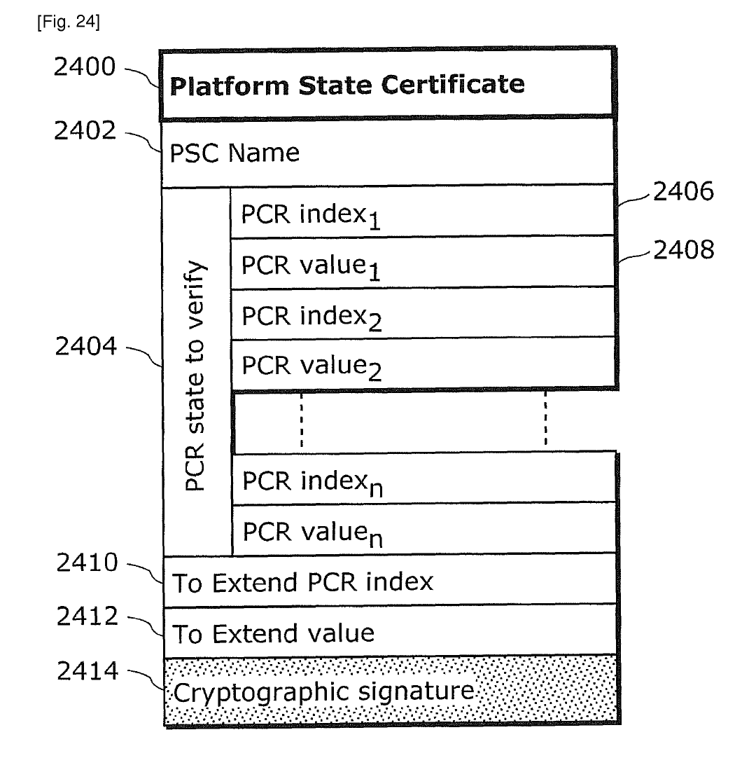

FIG. 24 illustrates a Platform State Certificate 2400 (PSC), the structure that represents the state of the platform as defined by the PCRs (either virtual or transient) that it asserts and the value to extend into a PCR (either virtual or transient) on a successful verification of the platform state. These structures may be stored in the PSC Database 2112. The first field within the structure is the PSC Name 2402. This name must be unique as it is the key field used to store and retrieve PSCs in the PSC Database 2112, and in the preferred implementation it is a byte string representing a human-readable name. The application developer may decide upon the name to use, or the manufacturer of the platform may provide names for the application developer. One ordinarily skilled in the art will see that other representations such as a GUID may be used instead, and there are other ways to choose the PSC names. Next, there is a list of entries representing the PCR state to verify 2404. For each PCR to be verified there is a pair of values, the PCR index 2406 and the PCR value 2408. Next, there is the PCR value to extend; first the To Extend PCR index 2410 then the To Extend value 2412. Finally there is a Cryptographic signature 2414 that represents a hash of the rest of the data encrypted by a key known to the Secure Processing Environment 2114. This signing key is either the private portion of a key securely embedded within the Secure Processing Environment 2114 or a key authorised either directly or indirectly by said embedded key as valid for signing PSCs, and the signing entity may be an agent of the platform developer or the application developer, or any other entity that has been issued with a valid signing key.

According to the current invention, by just looking at a Platform State Certificate 2400 one cannot determine whether it is for physical PCRs or transient PCRs. It is the context in which it is used that determines which kind of PCRs are to be checked. One benefit of this is that existing tools for creating certificates for secure boot can be reused for creating certificates for use in the application space.

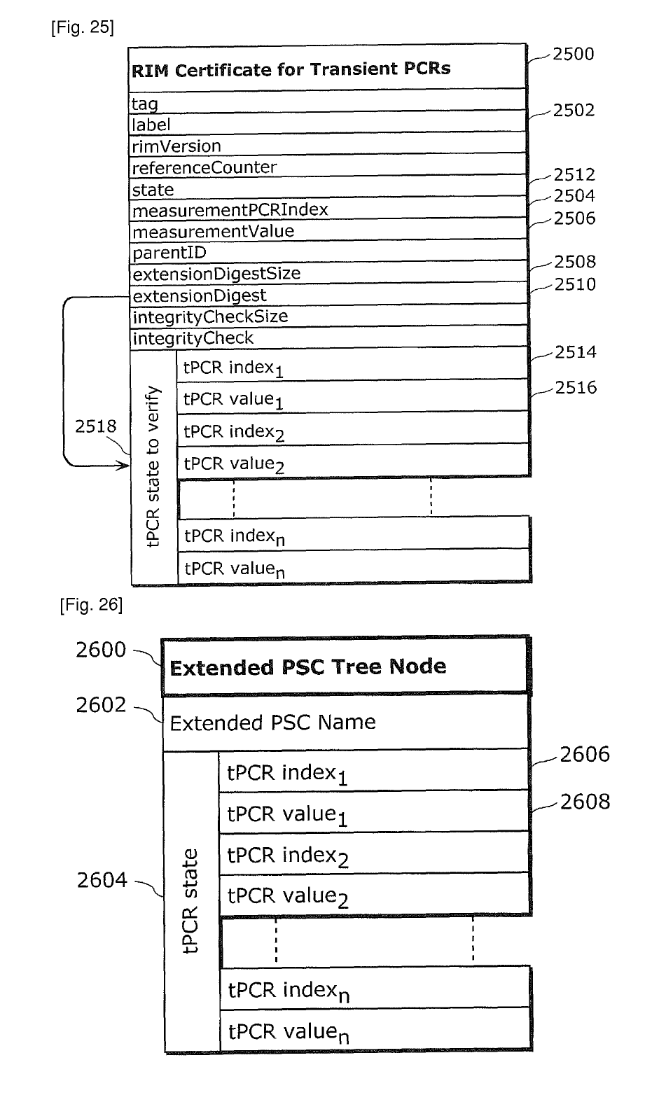

In a preferred implementation the PCR state to verify 2404 list of pairs may be replaced with a bitmap representing the PCR indices 2406 that are to be tested and a hash of the set of PCR values 2408; this is the representation defined by the TCG Mobile Trusted Module Specification for a RIM Certificate. It is possible to use such a representation without modification for certificates that verify transient PCRs, at the cost of more complex checking code, but a preferred implementation uses the RIM Certificate for Transient PCRs 2500 illustrated in FIG. 25. The relationships between fields in this structure and the Platform State Certificate in FIG. 24 and the additional fields will now be detailed.

The label 2502 is equivalent to the PSC Name 2402. The measurementPCRIndex 2504 and the measurementValue 2506 are equivalent to the To Extend PCR index 2410 then the To Extend value 2412. The tPCR state to verify 2518 and the contained list of pairs PCR index 2514 and the tPCR value 2516 are similar to the fields defined in the Platform State Certificate 2400. In order to associate the tPCR state to verify 2518 with the RIM Certificate for Transient PCRs 2500 it is necessary to use the extensionDigestSize 2508 and extensionDigest 2510 fields; the extensionDigestSize 2508 holds the size in bytes of the extensionDigest 2510 and the extensionDigest 2510 contains a hash of the tPCR state to verify 2518 structure. It is not necessary to store a size indicator as the number of bits set within the state 2512 field indicates the number of pairs in the table. One ordinarily skilled in the art will also see that it is not even necessary to store the tPCR index 2514 fields if there is a defined order of the tPCR value 2516 fields, such as tPCR index order.

FIG. 26 illustrates an Extended PSC Tree Node 2600, the structure that records the extending of a single certificate. This node structure details the contents of each node as illustrated in FIG. 23B, items 2350 to 2368. The Extended PSC Tree 2206 implements a directed acyclic graph using any well-known in the art techniques. For instance, the Boost C++ Libraries contain the Boost Graph Library, which supports the creation and manipulation of many kinds of graphs, including the above-mentioned directed acyclic graph. Thus, the Extended PSC Tree Node 2600 is associated with each vertex within the graph. The Extended PSC Name 2602 is the PSC Name 2402 field of a Platform State Certificate 2400 that has been extended. The tPCR state 2604 is a cache of the current transient PCR state at the node, as calculated from the previously-extended PSCs that are antecedents of this node. It consists of a list of pairs of tPCR index 2606 and tPCR value 2608. One ordinarily skilled in the art will see that there are alternative representations for this data, such as replacing the tPCR index 2606 fields with a bitmap representing the tPCRs used.

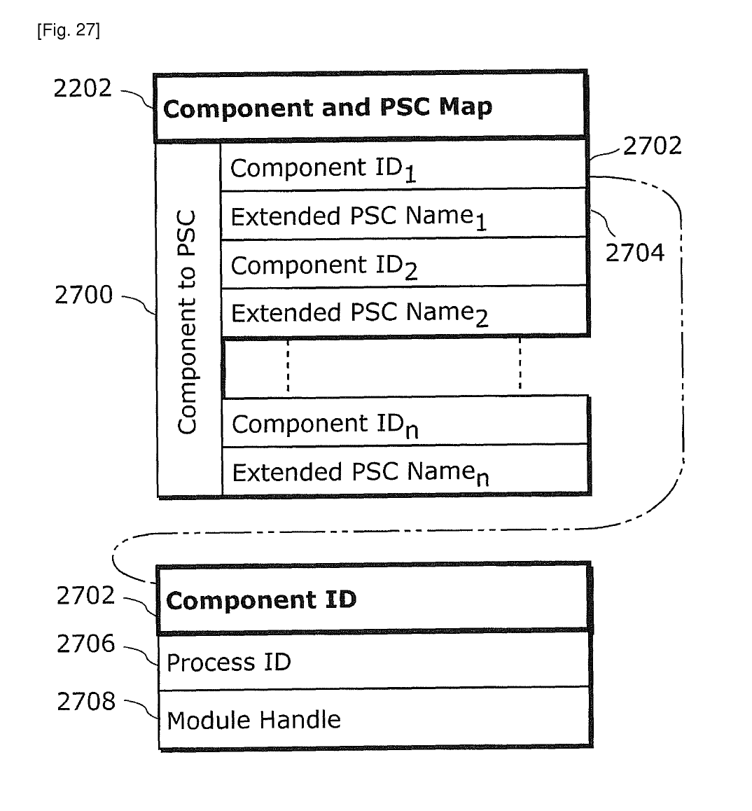

FIG. 27 illustrated the Component and PSC Map 2202 maintained by the OS support module 2200. The Component and PSC Map 2202 contains a list mapping Component to PSC 2700. Each entry of this list contains a Component ID 2702 and an Extended PSC Name 2704, the PSC Name 2402 field of a Platform State Certificate 2400 that has been extended before the launching of an application. In a preferred embodiment of the present invention on a Windows-based platform, the Component ID 2702 consists of two fields; the first is a Process ID 2706 which holds an identifier uniquely representing the process that the component belongs to, as determined by Win 32 APIs such as GetCurrentProcessId( ). The second field is a Module Handle 2708. For a component that is a stand-alone executable, this field is always set to zero. For a component implemented as a linked library, this field contains an HMODULE for the library, as passed into the DllMain entry point in the first parameter. The usage of this structure is described later.

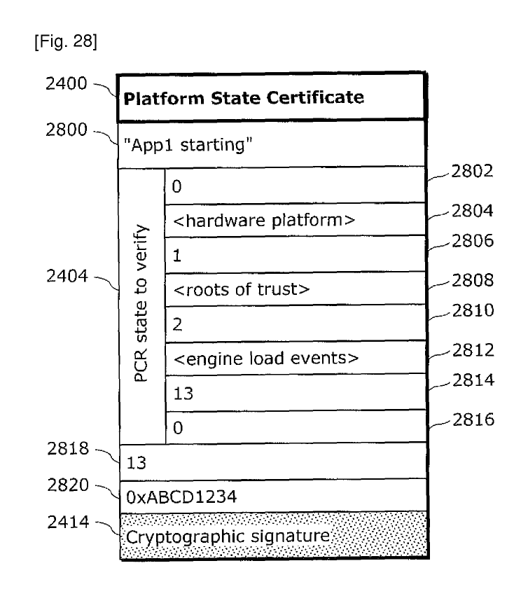

According to the TCG Mobile Reference Architecture, PCR 0 holds a value describing the characteristics of the underlying hardware platform; PCR 1 contains a value describing the Roots of Trust; PCR 2 engine load events; PCRs 3 to 6 and 8 to 12 contain proprietary measures; and PCR 13 to PCR 15 are free for application use. Assume an application programmer wanted to test PCRs 0, 1 and 2 were as expected indicating a successful secure boot, test PCR 13 was set to zeros, and if all were correct, extend a new value into PCR 13. FIG. 28 illustrates a sample Platform State Certificate 2400 named “App1 starting” according to the prior art. The name of the certificate is recorded in 2800, and as described above, the PCR state to verify 2404 contains four pairs of PCR index and PCR value to check, numbered 2802, 2804, 2806, 2808, 2810, 2812, 2814, and 2816, 2802 indicates PCR 0, 2804 the <hardware platform> notation indicates the published value representing the underlying hardware platform; 2806 indicates PCR 1, 2808 the <roots of trust> notation indicates the published value representing the underlying Roots of Trust; 2810 indicates PCR 2, 2812 the <engine load event> notation indicates the published value representing the composite hash calculated from the load event values extended into PCR 2; 2814 indicates PCR 13, 2816 the value of zero indicates expectation that the PCR 13 will still be in its initialized state. Next the PCR to extend to 2818 is present, then the value to extend into that PCR 2820.

The problems with the certificate in FIG. 28 according to the prior art include that if another application has used PCR 13, then the PCR state to verify 2404 will no longer be correct; and that if the application terminates then restarts the previously-extended value defined in 2818 and 2820 will have set PCR 13 to a non-zero state, thus the PCR state to verify 2404 will no longer be correct.

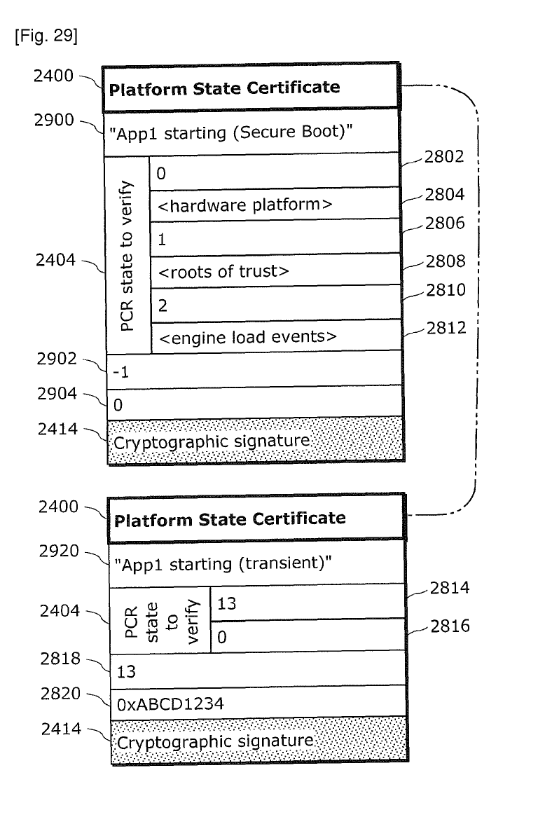

However, according to the current invention a certificate like the one in FIG. 28 is split into two certificates as illustrated in FIG. 29 by the application developer for deployment to the target device at either the same time as the application itself or at a separate time. The reason for making the split is that the existing certificates verify two distinct sets of PCRs; the first set contains the outcome of the secure boot process, a known non-varying result, and the second set the dynamic, application-level state. In FIG. 28, items 2802 and 2804 refer to the known secure boot PCR 0 value describing the hardware platform, items 2806 and 2808 refer to the known secure boot PCR 1 value describing the roots of trust, and items 2810 and 2812 refer to the known secure boot PCR 2 value describing the engine load events. In addition, items 2814 and 2816 refer to a desired post-boot PCR 13 value describing the expected preconditions. Thus, the developer of the application may split the single certificate in FIG. 28 into the two certificates illustrated in FIG. 29 by placing the known secure boot PCR values into one certificate that will be used to test the physical PCRs managed by the Secure Processing Environment, namely PCRs 0, 1 and 2 in this example. The second certificate is used for the application space transient PCRs, namely PCR 13 in this example.

The first certificate, named “App1 starting (Secure Boot)” 2900, tests the physical PCRs (PCR 0 2802, PCR 1 2806, and PCR 2 2810) set up by the secure boot process to ensure that the secure environment is correct. However, the PCR to extend to is set to −1 2902 to indicate that there is no extend, and the value to extend 2904 is a nominal value of zero; this certificate is for verification only; at the application level writing to physical PCRs is discouraged as illustrated in FIG. 23A, as using transient PCRs provides more flexibility and avoids the previously-mentioned problems present in the current state of the art. The second certificate, named “App1 starting (transient)” 2920, tests the transient PCR 13 2814 is zero 2816 and extends a value back to the same register 2818, 2820. The choice of tPCR index 13 is purely arbitrary; tPCR 0 or tPCR 99 could just as easily be used, unlike the situation with the prior art.

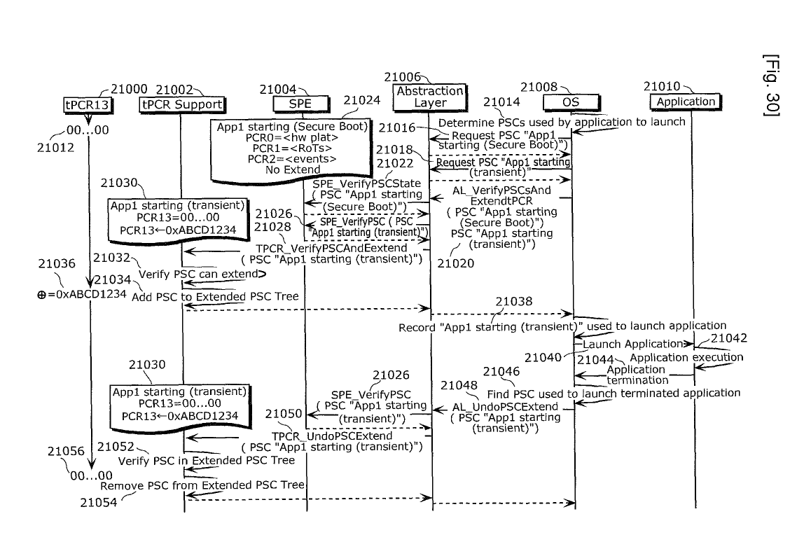

FIG. 30 illustrates a sequence chart that uses the two certificates from FIG. 29 when launching an application, one for testing the physical PCRs, the other for the transient PCRs, then uses the second “App1 starting (transient)” 2920 certificate on termination of the application to show a sequence of events according to the current invention that extends a value to a tPCR and then undoes it. Illustrated are six objects 21000, 21002, 21004, 21006, 21008 and 21010 that interact; first, tPCR 13 21000 represents the state of transient PCR 13 in the context of the current example. As illustrated in FIG. 26, tPCRs are recorded on a per node basis in the Extended PSC Tree 2206 rather than specific memory locations, but to aid understanding within this simple example, tPCR 13 21000 is represented as if it were such a location. Next, there is the tPCR Support 21002 which handles taking PSCs that refer to tPCRs and verifying the current tPCR state, and if valid, records that the certificate has been extended. SPE 21004 is the secure processing environment according to the prior art. In a preferred embodiment it is an MTM. Abstraction Layer 21006 handles requests from normal mode applications and passes requests to other modules. OS 21008 is the operating system, here concerned with handling launching and terminating applications such that the transient PCRs are correctly updates. Finally, Application 21010 is an application that requests the launching of other applications protected by PSCs, as the processes described in the sequence chart in FIG. 30 may be nested, so that for instance Application execution 21042 may include launching another application that will follow a sequence of events starting from 21014. In order to simplify the diagram error handling has been removed from the illustration, but this removal takes nothing away from the present invention.

First of all, tPCR 13 21000 starts off at a value of zero 21012. In the present invention the rule is that the root of the Extended PSC Tree 2206 starts of with a state that has all tPCRs set to zero. One skilled in the art will see that other possible initial values are possible, such as initialising the tPCRs with the values of the physical PCRs after secure boot completes. The OS 21008 detects a request to launch the Application 21010, so first it determines which PSCs are used by the application it will attempt to launch 21014. In a preferred embodiment on a Windows-based operating system, a custom assembly embedded into the executable identifies the two PSCs to use. The application is signed using Microsoft's Strong Name tool to protect against tampering. Next, the PSCs identified in 21014, in this illustration “App1 starting (Secure Boot)” and “App1 starting (transient)”, are requested 21016, 21018 from the Abstraction Layer 21006. Now, the verification of these two PSCs is performed by calling the Abstraction Layer API AL_VerifyPSCsAndExtendtPCR with the two PSCs for verifying the application that the system wishes to start 21020, namely the PSC for the physical PCRs and the PSC for the transient PCRs as illustrated in FIG. 29. First the SPE API SPE_VerifyPSCState is called 21022 with the PSC “App1 starting (Secure Boot)”, represented as 21024 in the diagram. According to the prior art, this performs a check on the format and the signature of the PSC itself, and then verifies that the PCRs to verify within the PSC match the current values in the physical PCRs. According to the prior art, when PSCs are delivered to the platform, they are signed with a key either embedded within the Secure Processing Environment 2114 or one that can be verified as authorised by said embedded key, and if valid they are re-signed with another key generated and securely stored by the Secure Processing Environment 2114 then the certificates are stored within the PSC database 2112.

According to a preferred embodiment of the present invention, the PSC for checking the physical PCRs is optional, so steps 21016 and 21022 may be omitted. According to another preferred embodiment, if the PSCs for checking the physical PCRs are identical for all applications, one PSC for physical PCRs may be used by two or more different transient PCR PSCs.

Next another API from the SPE is called, namely SPE_VerifyPSC 21026, with the parameter set to the PSC “App1 starting (transient)”, represented as 21030 in the diagram. According to the prior art, this performs a check on the format and the signature of the PSC itself without verifying the PCR settings against the physical registers. Now the tPCR Support module 21002 is called, namely the API TPCR_VerifyPSCAndExtend 21028 with the parameter set to the PSC “App1 starting (transient)”, represented as 21030 in the diagram. The first task of this API is to verify that the PSC can be extended 21032 by checking the PCR state to verify 2404 correspond to an existing state within the Extended PSC Tree 2206. The details of this operation are described later. Once the verification completes successfully, the success of the operation on this PSC is recorded by adding a representation of it to the correct position within the Extended PSC Tree 21034. The details of this operation are described later. One outcome of adding this PSC to the tree is that tPCR 13 21000, the register to be extended to, has its value set to a hash of a concatenation of the previous value, zero in this case, and the value to extend from the PCR 21030, 0xABCD1234. This is called a composite hash, and symbolically this is written as tPCRI3=SHA−1 (tPCR13 concatenated-with 0xABCD1234), and this operation is represented by the syntax (+)= in 21036. Thus, the environment has been verified to be in the expected state, and a record has been made of this success, so control passes back to the operating system. According to the prior art, as a further security measure before verifying the PSCs in 21020 a hash of the application is calculated and compared against a reference value stored within the PSC to extend. According to the present invention this value is stored within the PSC “App1 starting (transient)” 21030 as the value to extend, represented in the preferred embodiment by 0xABCD1234. However, this step is omitted from the figure.

On launching the application the OS obtains a process ID for the application and records within the Component and PSC Map 2202 this identifier and the corresponding PSC 21038 for the transient registers, PSC “App1 starting (transient)”. In a preferred embodiment on a Microsoft Windows environment this process is implemented by intercepting the process creation process as described in Intercepting WinAPI calls by Andriy Oriekhov at The Code Project http://www.codeproject.com/KB/system/InterceptWinAPICalls.aspx. The process handle obtained is converted to a Process ID 2706 and set to the said field, and the Module Handle 2708 is set to zero. When the component is a dynamic-link library, the LoadLibrary( ) and FreeLibrary( ) code is hooked and the call to DllMain ( ) trapped as described in Why does windows hold the loader lock whilst calling DllMain? by Len HolgateAPI at /*Rambling comments . . . */http://www.lenholgate.com/archives/000369.html. With this trap in place, the Process ID 2706 is set to the current process ID and the Module Handle 2708 is set to the first argument of DllMain( ).

The application is launched 21040, and continues to execute as programmed 21042, perhaps even launching other applications associated with PSCs or extending other PSCs that refer to tPCRs itself. Finally it terminates 21044, either due to user selecting to close it, due to a crash, or due to tamper detection by the Secondary RIC Monitor (not illustrated in this figure) forcing the application shut-down.

As the application terminates, the OS obtains the process ID of the application and uses it and a Module Handle of zero to make a Component ID 2702 that is used to look up the Component and PSC Map 2202 to find the PSC used to launch the application 21046. This returns PSC “App1 started (transient)” 21030, so the OS calls the Abstraction Layer 21006 API AL_UndoPSCExtend 21048 with the PSC to undo. When the component is a dynamic-link library, as described above the FreeLibrary( ) API is hooked, so within that routine the current process ID is queried and the Module Handle obtained from the FreeLibrary( ) parameter, and these two data items are used to make a Component ID 2702 that is used to look up the Component and PSC Map 2202 to find the PSC used to launch the library. As before another API from the SPE is called, namely SPE_VerifyPSC 21026, with the parameter set to the PSC “App1 starting (transient)”, represented as 21030 in the diagram. According to the prior art, this performs a check on the format and the signature of the PSC itself without verifying the PCR settings against the physical registers. Now the tPCR Support module 21002 is called, namely the API TPCR_UndoPSCExtend 21050 with the parameter set to the PSC “App1 starting (transient)”, represented as 21030 in the diagram. The first task of this API is to verify that the PSC has been extended 21052 by checking to see if the PSC is already present in the Extended PSC Tree 2206. The details of this operation are described later. Once the verification completes successfully, this means the extend operation in 21028 can be undone. This is achieved by deleting the node representing the PSC, and all other nodes that depend on it, from the Extended PSC Tree 21034. The details of this operation are described later. One outcome of deleting this PSC from the tree is that tPCR 13 21000, the register to be undone, effectively has its state reset to zero 21056. Thus, the environment has been verified to be in the expected state, and by deleting a node from the Extended PSC Tree 21034, the previously extend operation has been undone, so control passes back to the operating system, and the system is now ready to perform other operations. One ordinarily-skilled in the art will see that one of these other operations to perform is to restart the terminated application. Since tPCR 13 has been reset to 00 . . . 00 at 21056, the starting value for tPCR indicated at 21012, reperforming the verification of the application's starting PSC 21030 succeeds the second time around too, so according to the present invention applications can be restarted.

FIG. 30 illustrates the sequence chart for dynamically expanding and shrinking the trust boundary when launching and terminating an executable, with notes on how do perform the similar task for dynamic-link libraries based around a preferred embodiment using modules in the Windows Portable Executable format. For non Portable Executable-based module formats, such as Java Archive modules, or JARs, one ordinarily-skilled in the art will see that either a similar approach may be used by the engine that loads and unloads the modules, or alternatively explicit calls can be made to the Abstraction Layer 21006 by the modules themselves to expand and shrink the trust boundary. According to the prior art, JARs may contain not just Java byte codebased modules, but also other language modules, with one example being ECMAScript (JavaScript). These may be signed using the jarsigner tool from Sun at http://java.sun.com/j2se/1.3/docs/tooldocs/win32/jarsigner.html and the signature verified using the java.util.jar.JarFile class as described at http://java.sun.com/j2se/1.4.2/docs/api/java/util/jar/JarFile.html. In this case, in the preferred embodiment the Module Handle 2708 illustrated in FIG. 27 is a handle referring to the JAR file that contains the component.

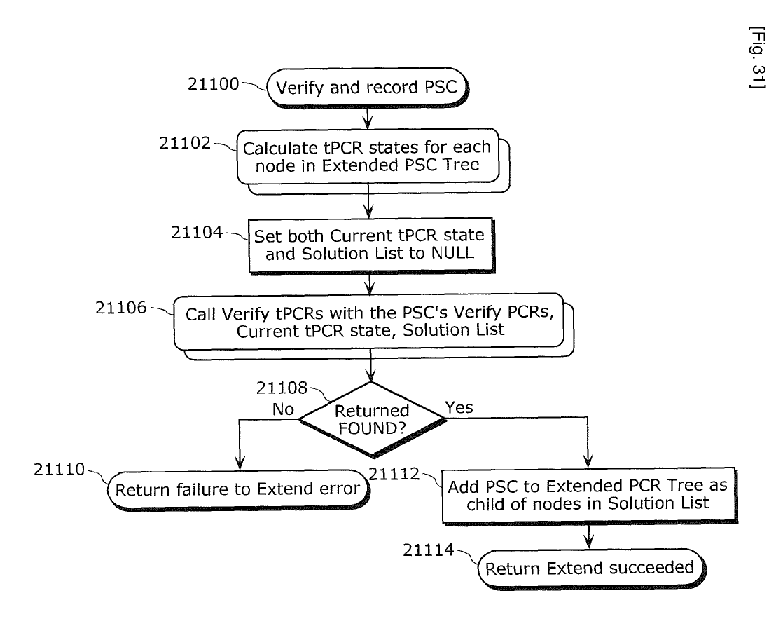

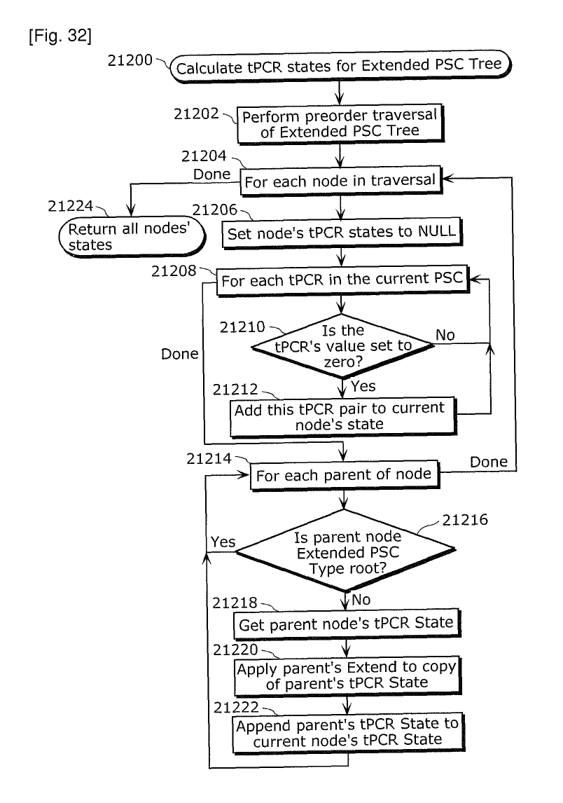

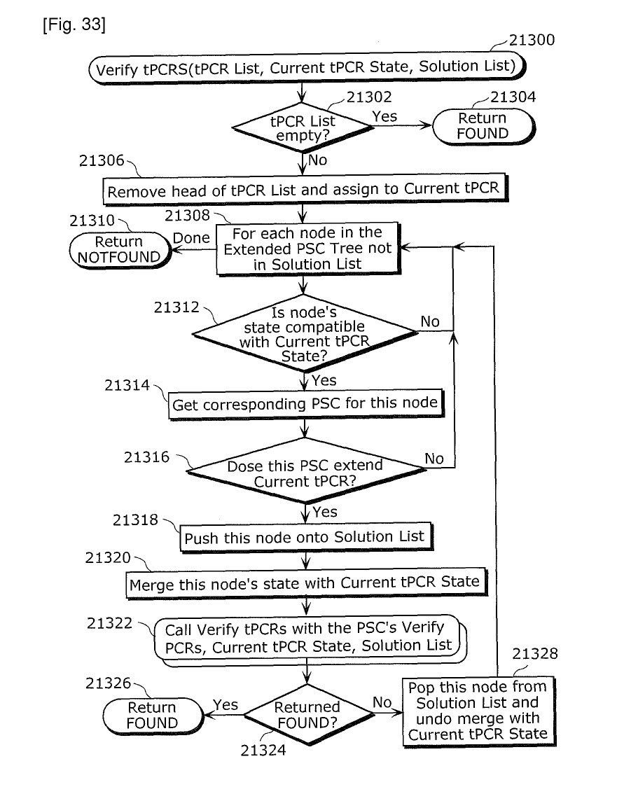

FIG. 31 illustrates a flow chart that describes the details of the tPCR Support module 21002 API TPCR_VerifyPSCAndExtend 21028. The function starts at 21100, with the PSC to verify and record being passed in as a parameter, and calls a subroutine that calculates the tPCR states for each node in the Extended PSC Tree 21102, illustrated in FIG. 32 below. Next, the Current tPCR State and Solution List variables are initialised to NULL 21104. The usage of these two variables is described in FIG. 33. Next, a subroutine that verifies the passed-in PSC's tPCR values can be reached from a state described by the current Extended PSC Tree 21106 is called. The return code is tested to see if the function found one or more nodes in the Extended PSC Tree that set the tPCRs to the state to verify held within in the passed-in PSC 21108. If this parent set was not found, the process returns an error code indicating a failure to extend to the calling routine 21110. If it was found, then the passed-in PSC is added to the Extended PSC Tree with its predecessors set to the nodes described by the Solution List 21112, and the process returns a success code to the calling routine 21114.

FIG. 32 illustrates a now chart that describes how the tPCR states 2604 within each node of the Extended PSC Tree in FIG. 26 are calculated. The flow chart is called with no arguments 21200 and the processing starts by performing a preorder traversal of the Extended PSC Tree 21202 starting from the root in order to collect the nodes of tree in the desired order for the following processing. In a preferred implementation, the Boost Graph Library function breadth_first_search( ) is used to collect these nodes. Next, for each node recorded by the depth-first traversal 21204 the current tPCR state 2604 is set to NULL 21206. Special processing for certificates that verify tPCRs initialised to the tPCR start values as defined on the completion of secure boot, zero in a preferred embodiment, are needed, so for each tPCR pair within the PCR state to verify 2404 stored within the current certificate 21208, the value is checked against the tPCR initial value as defined on the completion of secure boot, zero in a preferred embodiment 21210, and if they are equal this pair of tPCR index and value are added to this node's tPCR state 21212, and the loop continues for the next tPCR. Otherwise, the loop continues without adding to the node's tPCR state. Once each tPCR is check, the function moves on to loop for each parent of the current node 21214. If the parent node is the Extended PSC Tree root node 21216, then there is nothing to do as the previous loop dealt with this special case. Otherwise the parent node's tPCR state 2604 is queried and copied 21218. The Extend operation defined by the PSC referred to by the parent's Extended PSC Name 2602 is performed on the copy of the parent's state 21220, and the resultant tPCR state is appended onto the current node's tPCR state 21222. Due to the way this Extended PSC Tree is constructed, there will never be a situation where two parents specify different values for the same tPCR, so one ordinarily-skilled in the art will see that checking this condition is not necessary, but may be implemented for verification purposes. This collecting of tPCR states repeats for every parent as noted before, then when finished the next node in the traversal 21204 is processed. Once each node is thus processed, the process finishes by returning the tPCR states for each node 21224.

One ordinarily-skilled in the art will see there are other ways of performing the above algorithm, such as performing steps 21204 to 21222 within a bfs_visitor's examine_vertex( ), eliminating the need for a separate list of nodes. In addition, although this function is called every time a PSC-related operation is conducted, the values may be cached to reduce requited recalculation effort.

FIG. 33 illustrates a flow chart that describes how, once the tPCR states are calculated for each node, a given PSC is verified by finding a list of all the already Extended PSCs that set the tPCRs to the state defined within that given PSC. Note that the routine described in this figure is a recursive routine. The entry point to this routine takes as arguments the tPCR state to verify in the form of a list, the current matched tPCR state, and the list of nodes from the Extended PSC Tree that have been found to be parents of the PSC to match according to the tPCR state 21300. The outline of the solution method is for each tPCR index and value pair to try to find a certificate that extends the desired value into the current tPCR and is compatible with other certificates that extend into other tPCRs that are part of this solution. If a candidate is found, the routine is called recursively to find other certificates that extend the other tPCRs that are part of the PSC to match's state.

The first step is to check the list of tPCRs to match. If this is empty 21302, then the routine has successfully recursed to the end of the list, so return a FOUND value 21304 to indicate the success to the caller. Otherwise, the head of the tPCR list is removed and used as the Current tPCR to try to find a parent certificate for 21306. Each node in the Extended PSC Tree that has not already been assigned to the solution list is selected as a candidate for being a parent 21308. The description for FIG. 32 indicated how according to the prior art these nodes can be obtained. First, this node's tPCR state is checked for compatibility with the passed-in current matched tPCR state 21312, by verifying that matching tPCR indices in the two structures have the same tPCR values. If the values do not match 21316, the routine moves to the next node in the Extended PSC Tree 21308. If they do match, the PSC for the node to verify is retrieved using the Extended PSC Name 2602 stored in the node 21314, and the To Extend PSC index 2410 is compared with the index for the Current tPCR retrieved at 21306. If the indices do not match 21316, the routine moves to the next node in the Extended PSC Tree 21308. If the indices do match, then a candidate parent node has been found, so this node is pushed onto the solution list 21318 and this node's state with the Extend performed is merged with the current tPCR list. The Verify tPCRs routine is called recursively with the shortened tPCR list, the current tPCR state, and the solution list 21332. If the recursive call succeeds 21324, then a FOUND value 21326 is returned to indicate the success to the caller. If it fails, the current node is removed from the solution list and the merging of states in 21320 is undone 21328, and the loop continues to look at the next node in the tree. If all nodes are examined without a successful match, then NOTFOUND is returned 21310.

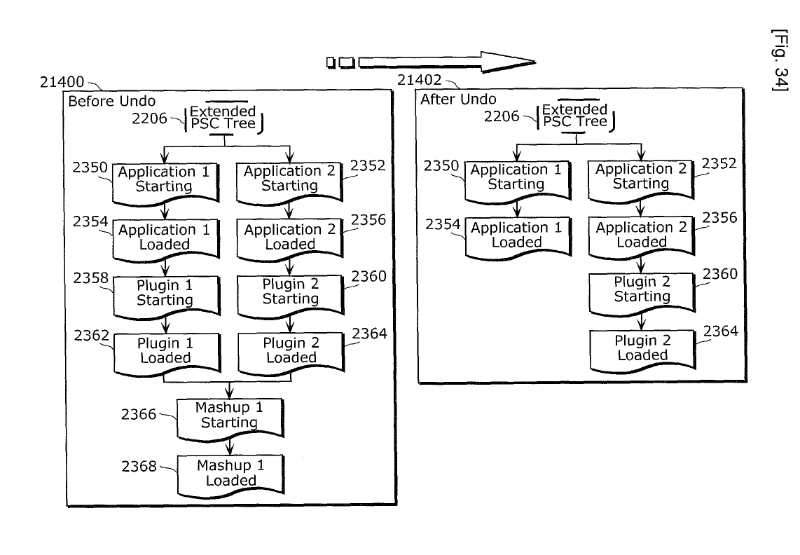

FIG. 34 illustrated the before undo and after undo states of a sample Extended PSC Tree 2206. The before undo state 21400 is as described in FIG. 23B, the resultant state built from the module tree in FIG. 23A. Now, if Plugin 1 terminates either due to user interaction, a program bug, or tamper detection, as illustrated in FIG. 30 the operating system detects this termination and determines that the certificate “Plugin 1 Starting” 2358 was the PSC tested at start-up, so that certificate's extend needs to be undone. Along with “Plugin 1 Starting” 2358, all the dependent certificates must also be removed from the Extended PSC Tree 2206, namely “Plugin 1 Loaded” 2362, “Mashup 1 Starting” 2366 and “Mashup 1 Loaded” 2368, leaving the Extended PSC Tree 2206 in the after undo state 21402.

FIG. 35 illustrates a flow chart that describes how the Extend process is undone. The function takes as an argument the Target PSC to undo 21500. First, the function calls a subroutine that calculates the tPCR states for each node in the Extended PSC Tree 21502, illustrated in FIG. 32 above. Next, the reference to the Target PSC is searched for within the Extended PSC Tree 21504, trying to find a match between the Target PSC's PSC Name 2402 and each node in the tree's Extended PSC Name 2602. If a matching node is not found 21506, an error code is returned to the caller to indicate the failure to undo 21512. Next, the Target PSC's PCR state to verify 2404 is compared with the found node's tPCR state 2604, and if the states are not equal 21510, an error code is returned to the caller to indicate the failure to undo 21512. If the states are equal, then a function to delete the found node and all its descendents 21514 is called, and the function returns a success code 21516 to the caller.

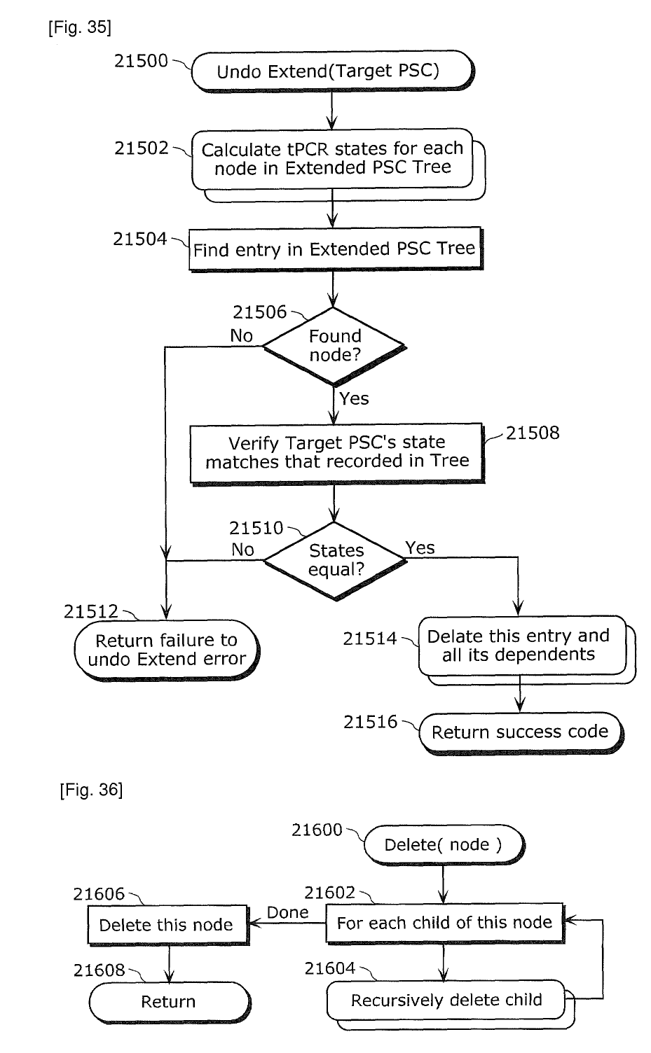

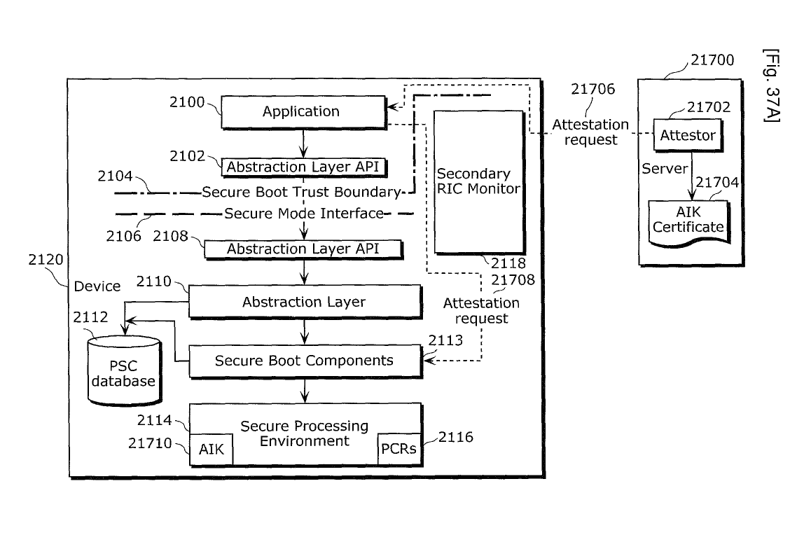

FIG. 36 illustrates a flow chart that describes how the undo process removes nodes from the Extended PSC Tree. The function takes as an argument the node to delete from the tree 21600. First it loops for every child PSC of this node 21602 and recursively calls itself to delete each of its children in turn 21604. Once all children are deleted, the node itself is deleted 21606 and the function returns 21608. Thus, the trust boundary established by previous extend operations covering the terminating modules and all its dependent trusted modules is shrunk to exclude the modules to terminate, while still covering the modules that need not be terminated and without compromising the level of trust in the application space of the device.

### Third Embodiment

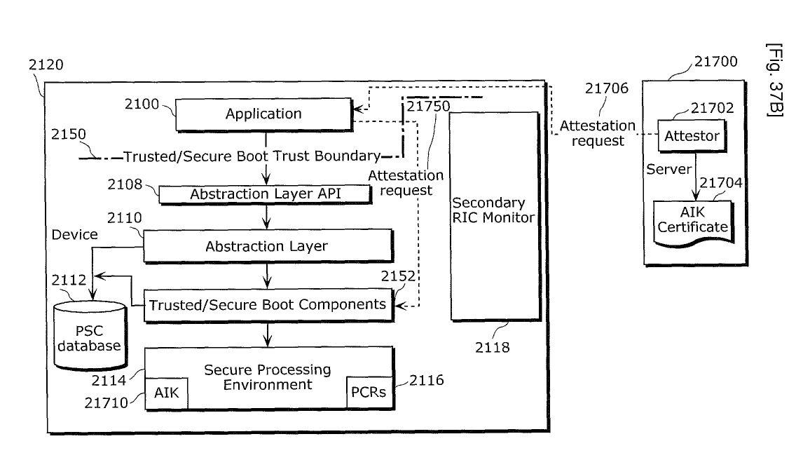

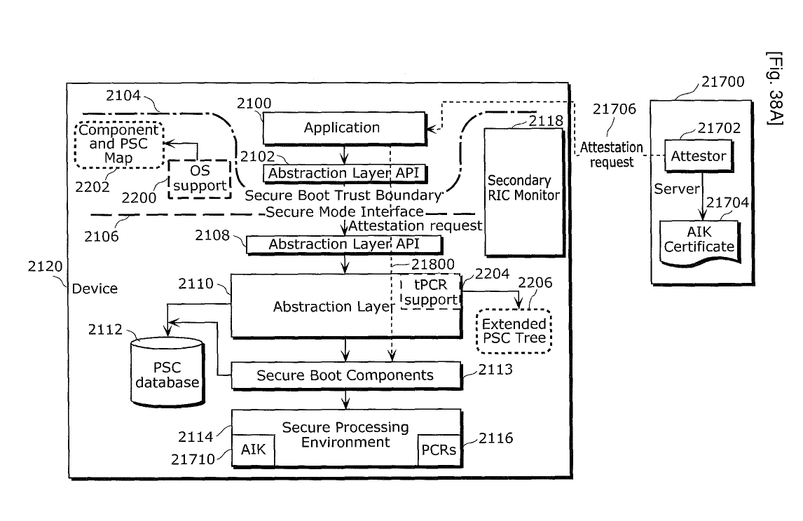

A third embodiment of the present invention is for remote attestation. According to the prior art, the process of remote attestation has two distinct phases. First, a shared AIK, Attestation Identity Key, is established between the client on the device and a remote server, perhaps using the Direct Anonymous Attestation protocol present in TPM v1.2. The next step is to use this AIK to attest to a particular device configuration; FIG. 37A and FIG. 37B illustrate the prior art for this remote attestation. The Device 2120 and the components within are as illustrated in FIG. 21A and FIG. 21B with the addition of an AIK 21710 stored within the Secure Processing Environment 2114. In FIG. 37A, illustrating the prior art when there is support for securely booting the system, there is also a Server 21700 that contains two components significant to the present invention. There is an Attestor 21702 that controls the attestation process, which uses an AIK Certificate 21704 that has been previously established and is associated with the Device's 2120 AIK 21710. The Attestor 21702 generates an Attestation request 21706 and sends it to the Application 2100 that requested attestation. The attestation process in the Application 2100 sends an Attestation request 21708 to the Secure Boot Components 2113, which in conjunction with the Secure Processing Environment 2114 carries out the attestation as defined by the prior art.

Similarly for FIG. 37B, illustrating the prior art when there is no support for secure mode but with an independent Secure Processing Environment 2114, such as the means described within the TCG Specification Architecture Overview Revision 1.2 28 Apr. 2004, and there is no secure mode interface. As before, there is also a Server 21700 that contains two components significant to the present invention. There is an Attestor 21702 that controls the attestation process, which uses an AIK Certificate 21704 that has been previously established and is associated with the Device's 2120 AIK 21710. The Attestor 21702 generates an Attestation request 21706 and sends it to the Application 2100 that requested attestation. The attestation process in the Application 2100 sends an Attestation request 21705 to the Trusted/Secure Boot Components 2152, which in conjunction with the Secure Processing Environment 2114 carries out the attestation as defined by the prior art.

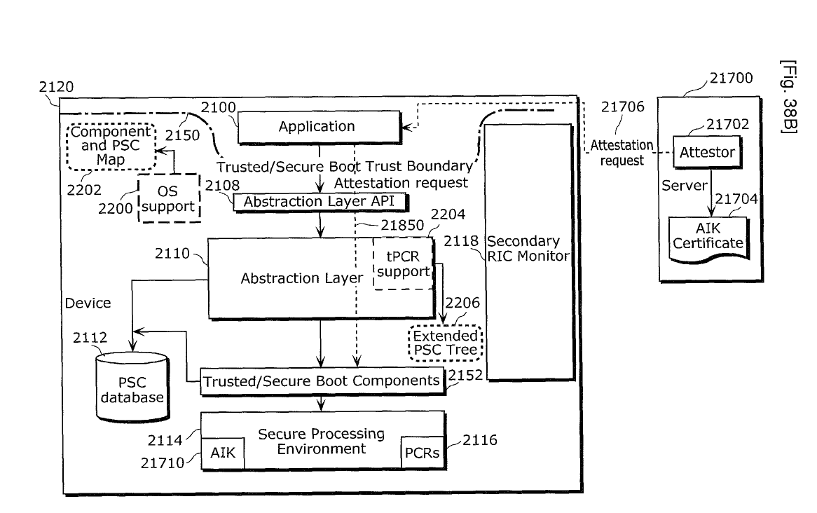

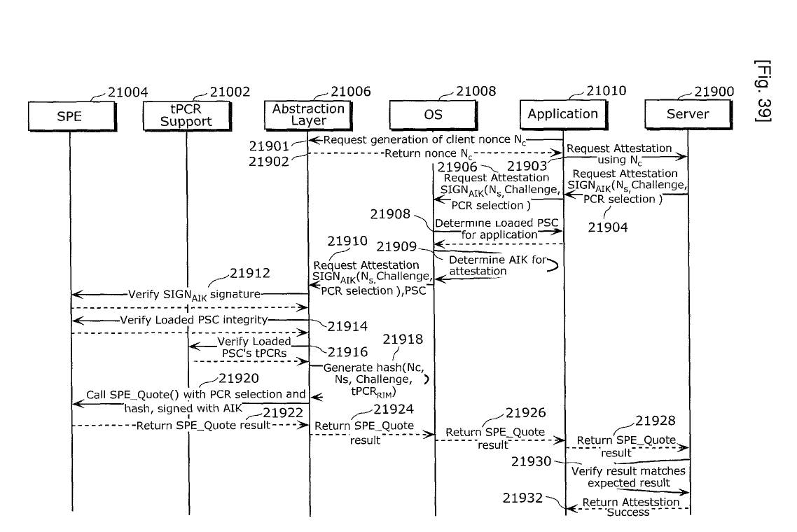

FIG. 38A illustrates the third embodiment of the present invention for remote attestation to transient PCRs, based on the prior art in FIG. 37A. The Server 21700 is as before, and the request for attestation 21706 as before is directed towards the Application 2100. However, according to the third embodiment instead of directing the Attestation request 21708 directly to the Secure Boot Components 2113, the Attestation request 21800 is directed through all the layers of the system so that information from the tPCR support 2204 may also be included within the attestation information returned to the server.

FIG. 38B illustrates another aspect of the third embodiment of the present invention for remote attestation to transient PCRs, based on the prior art in FIG. 37B. The Server 21700 is as before, and the request for attestation 21706 as before is directed towards the Application 2100. However, according to the third embodiment instead of directing the Attestation request 21708 directly to the Trusted/Secure Boot Components 2152, the Attestation request 21850 is directed through all the layers of the system so that information from the tPCR support 2204 may also be included within the attestation information returned to the server.

FIG. 39 illustrates a sequence chart that illustrates the inter-module communication during remote attestation of an application. Illustrated are six objects 21004, 21002, 21006, 21008, 21010 and 21900 that interact; first, SPE 21004 is the secure processing environment according to the prior art. In a preferred embodiment it is an MTM. Next, there is the tPCR Support 21002 which handles taking PSCs that refer to tPCRs and verifying the tPCR state according to a given PSC, and if valid, records that the certificate has been extended. Abstraction Layer 21006 handles requests from normal mode applications and passes requests to other modules. OS 21008 is the operating system, here concerned with handling launching and terminating applications such that the transient PCRs are correctly updates. Application 21010 is an application that requests remote attestation. Finally, Server 21900 performs the remote attestation.

First, the Application 21010 requests a client nonce N, 21901 from the Abstraction Layer 21006, and this randomly-generated value is returned 21902, which the Application 21010 uses when requesting attestation 21903 from the Server 21900. For example, before permitting access to secured services by the Application 21010, the Server 21900 needs to be sure that the Application 21010 is operating within the expected environment, thus the Application 21010 initiates the attestation procedure in order to obtain this permission from the Server 21900. The Application 21010 passes the generated client nonce N_{c} to the Server 21900, a value to protect against replay and other attacks on the communication stream between the Application 21010 and the Server 21900. The Server 21900 replies by sending its request for attestation 21904, with a message containing a server nonce Nₛ, a randomly generated Challenge, and a set of physical PCRs to query. This message is signed using an AIK that has previously been established between the client and server using, for instance, the Direct Anonymous Attestation protocol as described in the prior art. Note that in a preferred embodiment this message format is identical to that specified by the TCG. The Application 21010 delegates the processing of this attestation request 21906 to the OS 21008. The OS 21008 uses knowledge of the process space as described for FIG. 30 to determine which application or dynamic load library called the function and which PSC the module used to perform its self verification 21908 and to determine the AIK that has been previously established for remote attestation of the application 21909. The retrieved PSC is passed to the Abstraction Layer 21006 along with the other attestation parameters to request attestation from that module 21910. Now the attestation can start; first the signature on the message containing the server nonce, the random Challenge and the physical PCRs to attest to is verified 21912 by the SPE 21004 using the previously-established according to the prior art AIK. Next, the SPE 21004 is used again, this time to verify the integrity of the PSC 21914 for the Application 21010, and the tPCR Support 21002 is used to perform verification of the tPCRs set within said PSC 21916. Assuming that these checks were performed successfully, the Abstraction Layer 21006 prepares the hash value 21918 that will be used by SPE_Quote; this hash is calculated over the concatenation of the client nonce previously sent to the server, the server nonce and Challenge passed in at 21910, and the transient PCR hash stored within the Application's 21010 PSC. The SPE 21004 is requested to generate a signed hash 21922 including the PCRs set according to the PCR selection received from the server 21904 and the hash value calculated in 21918 and signed using the private portion of the established AIK. In the third embodiment where the SPE 21004 is an MTM, SPE_Quote is an alias for TPM_Quote and operates as defined by the TCG specification. This resultant signature value is then passed back up from the SPE 21004 to the Server 21900 through the sequence of 21922, 21924, 21926, and 21928. The Server 21900 verified that the result passed in equals the expected results 21930, and if so, notifies the Application 21010 that attestation has completed successfully 21932.

In the third embodiment the communication between the Application 21010 and the Server 21900 (21903, 21904, 21928, 21930, and 21932) takes place over a wireless link through the internet, but one ordinarily skilled in the art will see that embodiments using a fixed link or a radio link are also possible. The protocol for this communication is designed such that the message contents need not be encrypted, but one ordinarily skilled in the art will see that an embodiment using an encrypted protocol such as SSL is also possible.

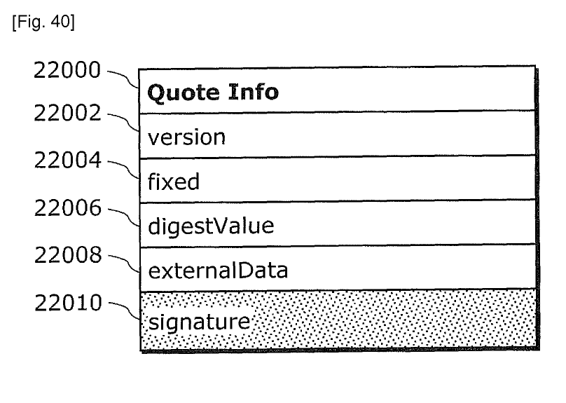

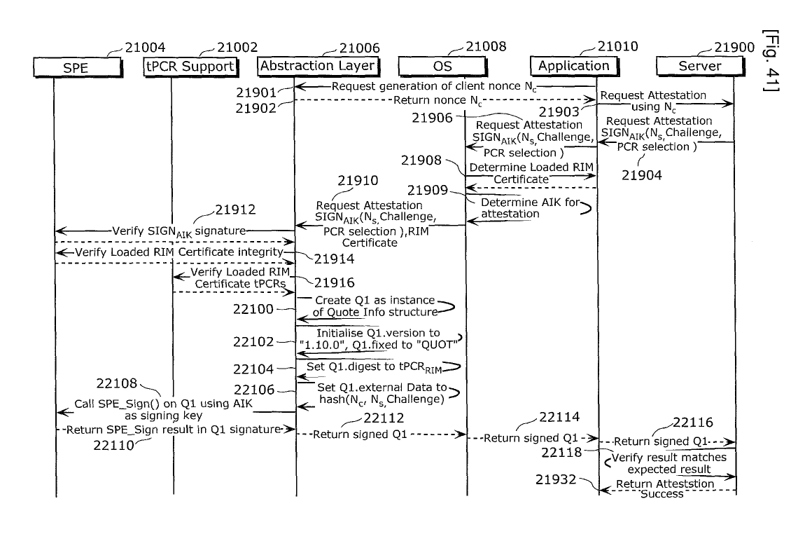

Alternatively, remote attestation to the tPCR values only may be required. FIG. 40 illustrates the structure of a Quote Info record 22000 that is used for remote attestation in this case. The version field 22002 contains a version indicator, defined as a constant value 1.1.0.0. The fixed field 2004 contains a structure type identifier, defined as a constant value “QUOT”. The digestValue field 22006 contains the tPCR digest value that is to be attested to. The externalData field 22008 contains external data, defined by the remote attestation protocol as a hash of a concatenation of the client nonce, the server nonce, and a challenge value. Finally, the signature field 22010 contains a cryptographic signature of the preceding fields. This signature will be generated using a key reference passed into the signature generation routine, defined by the remote attestation protocol as the previously-established AIK.

FIG. 41 illustrates the inter-module communication during remote attestation of an application to the tPCRs only using the Quote Info structure 22000 illustrated in FIG. 40. The first part of this communication sequence is identical to the sequence illustrated in FIG. 39. As before the Abstraction Layer 21006 uses the SPE 21004 to verify the attestation request's signature 21912 and to verify the transient PCR's PSC's integrity 21914, then uses the tPCR Support to verify the actual tPCR values within the PSC 21916. If the previously-mentioned verifications succeeded, from here the sequence diverges from FIG. 39. The Abstraction Layer 21008 creates a Quote Info structure 22000 named Q1 22100 and initialises the version field 22002 and fixed field 22004 to their respective pre-defined values 22102. Next the digest field is set to the digest of the fields within the previously-verified PSC 22106. This digest is calculated by hashing together all the PCR value, fields 2408 within the PCR state to verify 2404. Next, the externalData field 22008 is set to the hash of the of a concatenation of the client nonce, the server nonce, and the Challenge value 22106, these last two values being passed to the Abstraction Layer at 21910. With all the data correctly in place, the Abstraction Layer 21006 calls the SPE_Sign function 22108 within the SPE 21004 with these first four fields of the Quote Info 22000 as the data to cryptographically sign, and the last field, the signature 22010, as the location to save the signature, using the AIK as the key for signing. The behaviour of the SPE_Sign function 22108 is as detailed in the prior art for the TPM_Sign API. The result is placed into the signature field 22010 and returned 22110 to the Abstraction Layer 21006. This complete Quote Info structure 22000 is then passed back up from the Abstraction Layer 21006 to the Server 21900 through the sequence of 22112, 22114, and 22116. The Server 21900 verified that the result passed in equals the expected results 22118, and if so, notifies the Application 21010 that attestation has completed successfully 21932.

It should be noted that although the present invention is described based on aforementioned embodiment, the present invention is obviously not limited to such embodiment. The following cases are also included in the present invention.

(1) In aforementioned embodiment, the verification is performed in a similar manner to the MTM specifications. However, present invention can be applied to another verification system, as long as, the verification system can verify the components of the system using a verification method in which the component are verified like a chain (i.e. one component verifies another component which launch after the one component). For example, extending the hash value into MTM may be omitted, because this operation is specific for TCG specification.

(2) In aforementioned embodiment, the verification is performed by using hash values in a certificate (RIM Certificate). However, another verification method which does not use hash values may be applied to present invention.

Conventional check sum or other data extracted from the component (for example, a first predetermined bits extracted from the component) may be used to perform verification. Furthermore, the certificate may be replaced by a data group that includes the integrity check values.

In addition, the verification method is not limited to check whether or not a value extracted from the component and an expected value match. For example, checking the size of the component, and if the size is larger or smaller than a predetermined amount the component may be judged to be verified. These verification methods are not as strict as comparing a hash value with its expected value, however they are faster to perform.

(3) Each of the aforementioned apparatuses is, specifically, a computer system including a microprocessor, a ROM, a RAM, a hard disk unit, a display unit, a keyboard, a mouse, and the so on. A computer program is stored in the RAM or hard disk unit. The respective apparatuses achieve their functions through the microprocessor's operation according to the computer program. Here, the computer program is configured by combining plural instruction codes indicating instructions for the computer.

(4) A part or all of the constituent elements constituting the respective apparatuses may be configured from a single System-LSI (Large-Scale Integration). The System-LSI is a super-multi-function LSI manufactured by integrating constituent units on one chip, and is specifically a computer system configured by including a microprocessor, a ROM, a RAM, and so on. A computer program is stored in the RAM. The System-LSI achieves its function through the microprocessor's operation according to the computer program.

Furthermore, each unit of the constituent elements configuring the respective apparatuses may be made as separate individual chips, or as a single chip to include a part or all thereof.

Furthermore, here, System-LSI is mentioned but there are instances where, due to a difference in the degree of integration, the designations IC, LSI, super LSI, and ultra LSI are used.

Furthermore, the means for circuit integration is not limited to an LSI, and implementation with a dedicated circuit or a general-purpose processor is also available. In addition, it is also acceptable to use a Field Programmable Gate Array (FPGA) that is programmable after the LSI has been manufactured, and a reconfigurable processor in which connections and settings of circuit cells within the LSI are reconfigurable.

Furthermore, if integrated circuit technology that replaces LSI appears through progress in semiconductor technology or other derived technology, that technology can naturally be used to carry out integration of the constituent elements. Biotechnology is anticipated to apply.

(5) A part or all of the constituent elements constituting the respective apparatuses may be configured as an IC card which can be attached and detached from the respective apparatuses or as a stand-alone module. The IC card or the module is a computer system configured from a microprocessor, a ROM, a RAM, and the so on. The IC card or the module may also be included in the aforementioned super-multi-function LSI. The IC card or the module achieves its function through the microprocessor's operation according to the computer program. The IC card or the module may also be implemented to be tamper-resistant.

(6) The present invention, may be a computer program for realizing the previously illustrated method, using a computer, and may also be a digital signal including the computer program.

Furthermore, the present invention may also be realized by storing the computer program or the digital signal in a computer readable recording medium such as flexible disc, a hard disk, a CD-ROM, an MO, a DVD, a DVD-ROM, a DVD-RAM, a BD (Blu-ray Disc), and a semiconductor memory. Furthermore, the present invention also includes the digital signal recorded in these recording media.

Furthermore, the present invention may also be realized by the transmission of the aforementioned computer program or digital signal via a telecommunication line, a wireless or wired communication line, a network represented by the Internet, a data broadcast and so on.

The present invention may also be a computer system including a microprocessor and a memory, in which the memory stores the aforementioned computer program and the microprocessor operates according to the computer program.

Furthermore, by transferring the program or the digital signal by recording onto the aforementioned recording media, or by transferring the program or digital signal via the aforementioned network and the like, execution using another independent computer system is also made possible.

(7) Those skilled in the art will readily appreciate that many modifications are possible in the exemplary embodiment without materially departing from the novel teachings and advantages of this invention. Accordingly, arbitrary combination of the aforementioned modifications and embodiment is included within the scope of this invention.

### INDUSTRIAL APPLICABILITY

According to this structure, the information processing device manages the information showing which of the plurality of modules is an active module, and generates accumulated platform information by accumulating expected platform information of the active module.

Therefore, the information processing device can generate accumulated platform information corresponding to all active module(s). So, by performing verification by comparing the accumulated platform information with the expected platform information for first module to be booted, the information processing device can verify all modules to be loaded before the first module are loaded successfully. Furthermore, by managing which of the plurality of modules is an active module, the information processing device can dynamically generate accumulated platform information (corresponding to value of PCRs) according to current trusted boundary even after one or more modules are terminated.

### REFERENCE SIGNS LIST

1100 Application
1102, 1108 Abstraction Layer API
1104 Secure Boot Trust Boundary
1106 Secure Mode Interface
1110 Abstraction Layer
1112 PSC database
1113 Secure Boot Components
1114 Secure Processing Environment
1116 Physical PCRs
1118 Secondary RIC Monitor
1120 Device
1200 OS support
1202 Component and PSC Map
1204 tPCR support
1206 Extended PSC Tree

1-31. (canceled)

32. An information processing device comprising:
a storing unit configured to store expected platform information for each of a plurality of modules, the expected platform information showing which modules have been loaded before the each of a plurality of modules;
a management unit configured to record active information showing which of the plurality of modules are active modules, all active modules being modules that have been loaded and not been terminated; and
a load control unit configured to, when a next module is to be loaded:
(i) determine which of the plurality of modules are active modules using the active information;
(ii) generate accumulated platform information by accumulating expected platform information for each of the active modules;
(iii) determine the expected platform information for the next module;
(iv) generate a list of modules from the active modules such that the accumulated platform information for the list of modules equals the expected platform information for the next module;
(v) load the next module when the list of active modules is successfully generated; and
(vi) control said management unit to update the active information to show that the next module is active module when the next module is loaded.

33. The information processing device according to claim 32,
wherein said load control unit controls, when the next module is terminated, said management unit to update the active information to show that the next module is not an active module.

34. The information processing device according to claim 32,
wherein said management unit manages information showing the active modules by using a directed acyclic graph.

35. The information processing device according to claim 34,
wherein said load control unit controls, when the next module is loaded, said management unit to generate a node showing the next module and the expected platform information for the next module, and to add the generated node to the directed acyclic graph so that the generated node depends on nodes corresponding to the dependent modules.

36. The information processing device according to claim 35,
wherein said load control unit controls, when the next module has been loaded and terminated, said management unit to delete a node showing the next module and all nodes dependent on the node showing the next module.

37. The information processing device according to claim 36,
wherein said load control unit generates the accumulated platform information by searching a parent node on which the node showing the next module is to depend, and accumulating expected platform information of each node from a root of the directed acyclic graph to the parent node.

38. The information processing device according to claim 32,
wherein said load control unit deletes the accumulated platform information after a predetermined time period.

39. The information processing device according to claim 37,
wherein said load control unit deletes the accumulated platform information each time one of the plurality of modules is loaded successfully, and generates accumulated platform information each time when one of the plurality of modules is to be loaded.

40. The information processing device according to claim 32,
wherein the plurality of modules includes first module group and second module group, each of the first module group and the second module group including one or more modules,
said information processing device further comprises
a register unit configured to store first accumulated platform information, the first accumulated platform information showing which modules among the first module group has been loaded, and
said storing unit, further stores first expected platform information showing all modules among the first module group are to be loaded before loading a module among the second module group, and
said load control unit:
for a module among the first module group, (i) verifies the module, (ii) loads the module when the verification succeeds, and (iii) updates the first accumulated platform information by accumulating the platform information of the module to the first accumulated platform information when the module is loaded; and
when a module among the second module group is to be loaded, (i) verifies the all modules among the first module group have been loaded successfully by comparing the first expected platform information with the first accumulated platform information stored in said register unit, and
wherein, when the all modules among the first module group are verified to have been loaded successfully, said load control unit:
(i) determines which module among the second module group are active modules using the active information;
(ii) generates accumulated platform information by accumulating expected platform information for each of the active modules;
(iii) determines the expected platform information for the next module;
(iv) generates a list of modules from the active modules such that the accumulated platform information for the list of modules equals the expected platform information for the next module;
(v) loads the next module when the list of active modules is successfully generated; and
(vi) controls said management unit to update the active information to show that the next module is active module when the next module is loaded.

41. The information processing device according to claim 40,
wherein the first module group includes modules of a system layer, and
the second module group includes modules of an application layer.

42. An information processing method for an information processing device,
wherein the information processing device includes:
a storing unit which stores expected platform information for each of a plurality of modules, the expected platform information showing which modules are expected to have been loaded before the each of a plurality of modules; and
a management unit which records active information showing which of the plurality of modules are active modules, all active modules being modules that have been loaded and not been terminated, and
the information processing method comprises
a load control step of performing, when a next module following the active module is to be loaded:
(i) determining which of the plurality of modules are active modules, using the active information;
(ii) generating accumulated platform information by accumulating expected platform information for each of the active module;
(iii) determining the expected platform information for the next module;
(iv) generating a list of modules from the active modules such that the accumulated platform information for the list of modules equals the expected platform information for the next module;
(v) loading the next module when the list of active modules is successfully generated; and
(vi) controlling the management unit to update active information to show that the next module is active module when the next module is loaded.

43. A non-transitory computer-readable recording medium for use in a computer, which is encoded with a computer program for an information processing device,
wherein the information processing device includes:
a storing unit which stores expected platform information for each of a plurality of modules, the expected platform information showing which modules are expected to have been loaded before the each of a plurality of modules; and
a management unit which records active information showing which of the plurality of modules are active modules, all active modules being modules that have been loaded and not been terminated; and
the program, which when loaded into the information processing device, causes the information processing device to execute
a load control step of performing, when a next module following the active module is to be loaded:
(i) determining which of the plurality of modules are active modules, using the active information;
(ii) generating accumulated platform information by accumulating expected platform information for each of the active modules;
(iii) determining the expected platform information for the next module;
(iv) generating a list of modules from the active modules such that the accumulated platform information for the list of modules equals the expected platform information for the next module;
(iii) loading the next module when the list of active modules is successfully generated; and
(iv) control the management unit to update active information to show that the next module is active module when the next module is loaded.

44. An integrated circuit device, used in an information processing device,
wherein the information processing device includes:
a storing unit configured to store expected platform information for each of a plurality of modules, the expected platform information showing which modules are expected to have been loaded before the each of a plurality of modules; and
a management unit configured to record information showing which of the plurality of modules are active modules, all active modules being modules that have been loaded and not been terminated, and
said integrated circuit device comprises
a load control unit configured to, when a next module following the active module is to be loaded:
(i) determine which of the plurality of modules are active modules, using the active information;
(ii) generate accumulated platform information by accumulating expected platform information for each of the active modules;
(iii) determine the expected platform information for the next module;
(iv) generate a list of modules from the active modules such that the accumulated platform information for the list of modules equals the expected platform information for the next module;
(v) load the next module when the list of active modules is successfully generated; and
(iv) control the management unit to update active information to show that the next module is active module when the next module is loaded.

45. The information processing device according to claim 32,
wherein said information processing device is connected to a server, and
said load control unit is further configured to, when a request for verifying expected accumulated platform information is received from the server:
(i) determine which of the plurality of modules are active modules using the active information;
(ii) generate accumulated platform information by accumulating expected platform information for each of the active modules;
(iii) determine the expected platform information for the next module;
(iv) generate a list of modules from the active modules such that the accumulated platform information for the list of modules equals the expected platform information for the next module; and
(iii) send the accumulated platform information to the server, when the list of active modules is successfully generated.

46. The information processing device according to claim 45,
wherein said load control unit is further configured to:
(i) generate information showing which piece of the expected platform is used to generate the accumulated platform information;
(ii) generate signature information used for verifying the accumulated platform information based on the information; and
(iii) send the accumulated platform information to which the signature information is attached to.

47. The information processing device according to claim 45,
wherein said load control unit controls, when a next module is terminated, said management unit to update the active information to show that the next module is not an active module.

48. The information processing device according to claim 45,
wherein said management unit manages information showing the active modules by using a directed acyclic graph.

49. The information processing device according to claim 48,
wherein said load control unit controls, when the next module is loaded, said management unit to generate a node showing the next module and the expected platform information for the next module, and to add the generated node to the directed acyclic graph so that the generated node depends on nodes corresponding to the dependent modules.

50. The information processing device according to claim 49,
wherein said load control unit controls, when the one module has been loaded and terminated, said management unit to delete a node showing the next module and all nodes dependent on the node showing the next module.

51. The information processing device according to claim 50,
wherein said load control unit generates the accumulated platform information by searching a parent node on which the node showing the next module is to depend, and accumulating expected platform information of each node from a root of the directed acyclic graph to the parent node.

52. The information processing device according to claim 45,
wherein said load control unit deletes the accumulated platform information after a predetermined time period.

53. The information processing device according to claim 51,
wherein said load control unit deletes the accumulated platform information each time one of the plurality of modules is loaded successfully, and generates accumulated platform information each time when one of the plurality of modules is to be loaded.

54. The information processing device according to claim 45,
wherein the plurality of modules includes first module group and second module group, each of the first module group and the second module group including one or more modules,
said information processing device further comprises
a register unit configured to store first accumulated platform information, the first accumulated platform information showing which modules among the first module group has been loaded, and
said storing unit, further stores first expected platform information showing all modules among the first module group are to be loaded before loading a module among the second module group, and
said load control unit:
for a module among the first module group, (i) verifies the module, (ii) loads the module when the verification succeeds, and (iii) updates the first accumulated platform information by accumulating the platform information of the module to the first accumulated platform information when the module is loaded; and
when a module among the second module group is to be loaded, (i) verifies the all modules among the first module group have been loaded successfully by comparing the first expected platform information with the first accumulated platform information stored in said register unit, and
wherein, the all modules among the first module group are verified to have been loaded successfully, said load control unit:
(i) determines which module among the second module group are active modules using the active information;
(ii) generates accumulated platform information by accumulating expected platform information for each of the active modules;
(iii) determines the expected platform information for the next module;
(iv) generates a list of modules from the active modules such that the accumulated platform information for the list of modules equals the expected platform information for the next module;
(v) loads the next module when the list of active modules is successfully generated; and
(vi) controls said management unit to update the active information to show that the next module is active module when the one module is loaded.

55. The information processing device according to claim 54,
wherein the first module group includes modules of a system layer, and
the second module group includes modules of an application layer.

56. The information processing method according to claim 42, further comprising:
a receiving step of receiving, from a server, a request for sending the accumulated platform information; and
a sending step of performing, when said receiving unit receives the request:
(i) determining which of the plurality of modules are active modules, using the active information;
(ii) generating accumulated platform information by accumulating expected platform information for each of the active module;
(iii) determining the expected platform information for the next module;
(iv) generating a list of modules from the active modules such that the accumulated platform information for the list of modules equals the expected platform information for the next module; and
(v) sending the accumulated platform information to the server, when the list of active modules is successfully generated.

57. The recording medium according to claim 43,
wherein the program further causes the information processing device to execute:
a receiving step of receiving, from a server, a request for sending the accumulated platform information; and
a sending step of performing, when said receiving unit receives the request,
(i) determining which of the plurality of modules are active modules, using the active information;
(ii) generating accumulated platform information by accumulating expected platform information for each of the active modules;
(iii) determining the expected platform information for the next module;
(iv) generating a list of modules from the active modules such that the accumulated platform information for the list of modules equals the expected platform information for the next module, and
(v) sending the accumulated platform information to the server, when the list of active modules is successfully generated.

58. The integrated circuit device according to claim 44, further comprising:
a receiving unit configured to receive, from a server, a request for sending the accumulated platform information; and
a sending unit configured to, when said receiving unit receives the request,
(i) determine which of the plurality of modules is an active module, using the active information;
(ii) generate accumulated platform information by accumulating expected platform information for each of the active modules,
(iii) determine the expected platform information for the next module;
(iv) generate a list of modules from the active modules such that the accumulated platform information for the list of modules equals the expected platform information for the next module, and
(v) send the accumulated platform information to the server, when the list of active modules is successfully generated.
